(19) United States
(12) Patent Application Publication
(10) Pub. No.: US 2026/0089229 A1
(43) Pub. Date: Mar. 26, 2026

(54) ANALYSIS SYSTEM, SYSTEM, AND AUTOMATIC SENDING SYSTEM

(71) Applicant: KYOCERA Document Solutions Inc., Osaka-shi (JP)

(72) Inventor: Koki Nakajima, Osaka (JP)

(21) Appl. No.: 19/340,592

(22) Filed: Sep. 25, 2025

(30) Foreign Application Priority Data
Sep. 26, 2024 (JP) 2024-167869
Sep. 26, 2024 (JP) 2024-167870

(51) Int. Cl. H04L 67/50; G06Q 10/107

(52) U.S. Cl. CPC H04L 67/535; G06Q 10/107

(57) ABSTRACT

An analysis system outputs an analysis result related to an e-mail. The e-mail is delivered by a mail delivery system that delivers the e-mail to users of software as a service (SaaS) provided by a SaaS providing system that provides the SaaS. The analysis result is based on a detection result of a tracking system that detects at least one of opening of the e-mail or clicking of a link in the e-mail and on a utilization rate of the SaaS.

### INCORPORATION BY REFERENCE

This application is based upon and claims the benefit of priority from the corresponding Japanese Patent Application No. 2024-167869 filed on Sep. 26, 2024, and 2024-167870 filed on Sep. 26, 2024, the entire contents of which are incorporated herein by reference.

FIELD The present disclosure relates to an analysis system, a system, an information processing apparatus, and an analysis program storage medium that promote the utilization of a software as a service (SaaS).

### BACKGROUND

Conventionally, a technology that promotes the utilization of the SaaS by a user is known.

### SUMMARY

The analysis system according to the present disclosure outputs an analysis result related to an e-mail, the e-mail being delivered by a mail delivery system that delivers the e-mail to users of software as a service (SaaS) provided by a SaaS providing system that provides the SaaS, the analysis result being based on a detection result of a tracking system that detects at least one of opening of the e-mail or clicking of a link in the e-mail and on a utilization rate of the SaaS.

The analysis system according to the present disclosure may divide the users of the SaaS into a plurality of segments in accordance with the utilization rate and show an open rate of the e-mail for each of the segments is as the analysis result.

The analysis system according to the present disclosure may divide the users of the SaaS into a plurality of segments in accordance with the utilization rate and show a click rate of the link for each of the segments as the analysis result.

The analysis system according to the present disclosure may show the utilization rate before and after opening the e-mail as the analysis result.

The analysis system according to the present disclosure may show the utilization rate before and after clicking on the link as the analysis result.

The system according to the present disclosure includes: a software as a service (SaaS) providing system that provides SaaS; a mail delivery system that delivers an e-mail to users of the SaaS provided by the SaaS providing system; a tracking system that detects at least one of opening of the e-mail delivered by the mail delivery system or clicking of the link in the e-mail; and an analysis system that outputs an analysis result related to the e-mail, the analysis result being based on a detection result of the tracking system and a utilization rate of the SaaS.

An information processing apparatus according to the present disclosure outputs an analysis result related to an e-mail, the e-mail being delivered by a mail delivery system that delivers the e-mail to users of software as a service (SaaS) provided by a SaaS providing system that provides the SaaS, the analysis result being based on a detection result of a tracking system that detects at least one of opening of the e-mail or clicking of a link in the e-mail and on a utilization rate of the SaaS.

An analysis program storage medium according to the present disclosure is a non-transitory computer-readable storage medium that stores the above-mentioned analysis program. The analysis program causes a computer to show an analysis result related to an e-mail, the e-mail being delivered by a mail delivery system that delivers the e-mail to users of software as a service (SaaS) provided by a SaaS providing system that provides the SaaS, the analysis result being based on a detection result of a tracking system that detects at least one of opening of the e-mail or clicking of a link in the e-mail and on a utilization rate of the SaaS.

An automatic sending system according to the present disclosure automatically sends an e-mail according to a segment of users of software as a service (SaaS), who are divided in accordance with a utilization rate of SaaS provided by a SaaS providing system that provides the SaaS, to the users of the SaaS.

The automatic sending system according to the present disclosure may send the e-mail according to a first segment, which is the segment, more frequently than the e-mail according to a second segment, which is the segment higher in the utilization rate than the first segment.

The system according to the present disclosure includes: a software as a service (SaaS) providing system that provides SaaS; and an automatic sending system that automatically sends an e-mail according to a segment of users of the SaaS, who are divided in accordance with a utilization rate of the SaaS, to the users of the SaaS.

The information processing apparatus according to the present disclosure automatically sends an e-mail according to a segment of users of software as a service (SaaS), who are divided in accordance with a utilization rate of the SaaS provided by a SaaS providing system that provides the SaaS, to the users of the SaaS.

An automatic sending program storage medium according to the present disclosure is a non-transitory computer-readable storage medium that stores the above-mentioned automatic sending program. The automatic sending program causes the computer to automatically send an e-mail according to a segment of users of software as a service (SaaS), who are divided in accordance with a utilization rate of the SaaS provided by a SaaS providing system that provides the SaaS, to the users of the SaaS.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an example of a system according to Embodiment 1 of the present disclosure.

FIG. 2 is a block diagram of an example of a SaaS providing system shown in FIG. 1 in a case where it is constituted by a single computer.

FIG. 3 is a diagram showing an example of tenant management information shown in FIG. 2.

FIG. 4 is a diagram showing an example of tenant user management information shown in FIG. 2.

FIG. 5 is a diagram showing an example of utilization history information shown in FIG. 2.

FIG. 6 is a block diagram of an example of a mail delivery system shown in FIG. 1 in a case where it is constituted by a single computer.

FIG. 7 is a diagram showing an example of sender management information shown in FIG. 6.

FIG. 8 is a diagram showing an example of a tracking database shown in FIG. 1.

FIG. 9 is a block diagram of an example of a tracking system shown in FIG. 1 in a case where it is constituted by a single computer.

FIG. 10 is a block diagram of an example of an analysis system shown in FIG. 1 in a case where it is constituted by a single computer.

FIG. 11 is a diagram showing an example of analyst management information shown in FIG. 10.

FIG. 12 is a block diagram of an example of a SaaS utilization apparatus shown in FIG. 1.

FIG. 13 is a block diagram of an example of a sender terminal shown in FIG. 1.

FIG. 14 is a block diagram of an example of a customer terminal shown in FIG. 1.

FIG. 15 is a block diagram of an example of an analyst terminal shown in FIG. 1.

FIG. 16 is a sequence diagram of an operation of the system shown in FIG. 1 in a case of sending an e-mail in accordance with a phase of utilization of a customer with respect to the SaaS provided by the SaaS providing system.

FIG. 17 is a sequence diagram of an operation of the system shown in FIG. 1 in a case where a general user logs in the SaaS providing system.

FIG. 18 is a sequence diagram of an operation of the system shown in FIG. 1 in a case where the general user utilizes the SaaS.

FIG. 19 is a sequence diagram of an operation of the system shown in FIG. 1 in a case where the general user logs out of the SaaS providing system.

FIG. 20 is a flowchart of an operation of the analysis system shown in FIG. 10 in a case of collecting the utilization history information from the SaaS providing system.

FIG. 21 is a sequence diagram of an operation of the system shown in FIG. 1 in a case of delivering an e-mail in accordance with an instruction made by a sender.

FIG. 22 is a sequence diagram of an operation of the system shown in FIG. 1 in a case where the customer opens the e-mail delivered by the mail delivery system.

FIG. 23 is a flowchart of an operation of the analysis system shown in FIG. 10 in a case of collecting tracking data from the tracking database.

FIG. 24 is a sequence diagram of an operation of the system shown in FIG. 1 in a case where the analysis system analyzes data in accordance with an instruction made by an analyst.

FIG. 25 is a block diagram of an example of a system according to Embodiment 2 of the present disclosure.

FIG. 26 is a block diagram of an example of an automatic sending system shown in FIG. 25 in a case where it is constituted by a single computer.

FIG. 27 is a sequence diagram of an operation of the system shown in FIG. 25 in a case where the automatic sending system sends an e-mail to the mail delivery system in accordance with an analysis result of the analysis system.

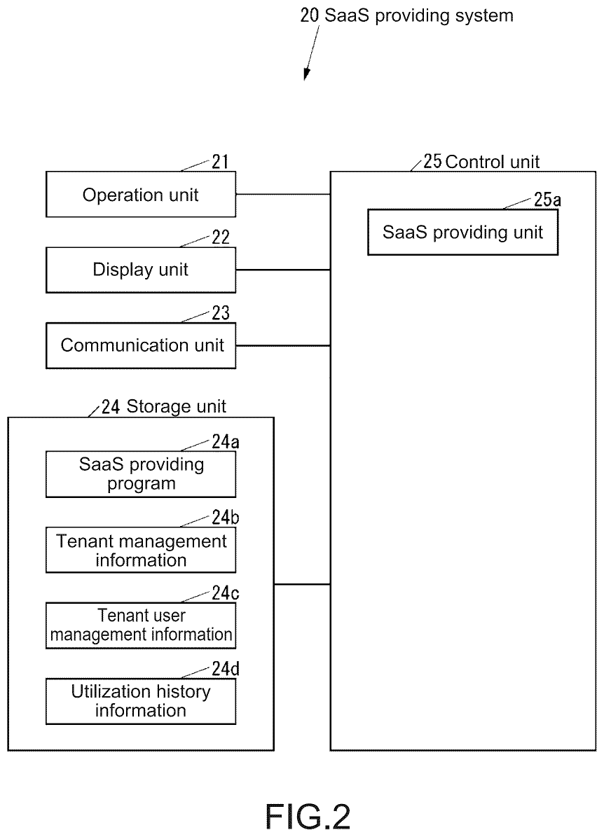

(a) of FIG. 28 is a list of tenant users for which the utilization rate of the SaaS provided by the SaaS providing system shown in FIG. 2 is equal to or higher than 30% and (b) of FIG. 28 is a list of tenant users for which the utilization rate of the SaaS provided by the SaaS providing system shown in FIG. 2 is lower than 30%.

### DETAILED DESCRIPTION

### Embodiment 1

Hereinafter, Embodiment 1 of the present disclosure will be described with reference to the drawings.

First of all, a configuration of a system according to Embodiment 1 of the present disclosure will be described.

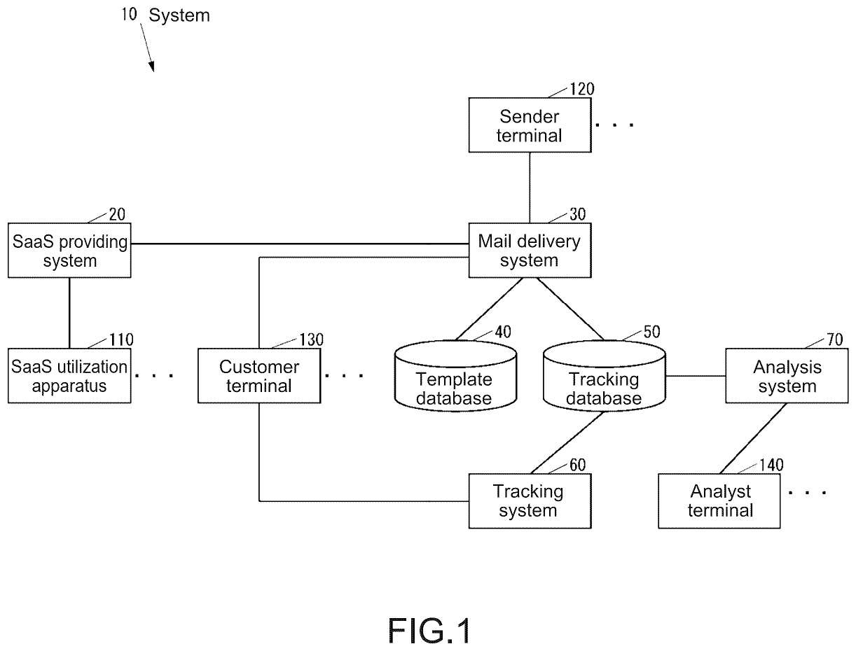

FIG. 1 is a block diagram of an example of a system 10 according to the present embodiment.

As shown in FIG. 1, the system 10 includes a SaaS providing system 20 that provides SaaS. The SaaS providing system 20 may be constituted by a single computer such as a personal computer (PC) or may be constituted by a plurality of computers. The SaaS providing system 20 may be configured on a cloud.

The system 10 includes a mail delivery system 30 that delivers an e-mail in the format of hypertext markup language (HTML). The mail delivery system 30 may be constituted by a single computer such as a PC or may be constituted by a plurality of computers. The mail delivery system 30 may be configured on a cloud.

The system 10 includes a template database 40. The template database 40 is a database that stores a template, which is data in the HTML format that saves the design of the e-mail delivered by the mail delivery system 30. The template can be created by design view or HTML code.

The system 10 includes a tracking database 50. The tracking database 50 is a database that stores tracking data indicating a status in which a recipient of the e-mail delivered by the mail delivery system 30 is viewing this e-mail. For example, the tracking data includes open tracking indicating the number of times by which the recipient has opened the e-mail delivered by the mail delivery system 30 and the number of times by which the recipient has opened a page which is a link destination of each link in the e-mail delivered by the mail delivery system 30, i.e., click tracking indicating the number of clicks of each link.

The system 10 includes a tracking system 60 that tracks views of the e-mail delivered by the mail delivery system 30. The tracking system 60 may be constituted by a single computer such as a PC or may be constituted by a plurality of computers. The tracking system 60 may be configured on a cloud.

The system 10 includes an analysis system 70 that executes analysis according to key performance indicator (KPI) on the basis of data indicating a utilization status of the SaaS providing system 20 and tracking data. The analysis system 70 may be constituted by a single computer such as a PC or may be constituted by a plurality of computers. The analysis system 70 may be configured on a cloud.

The system 10 includes a SaaS utilization apparatus 110 that utilizes the SaaS provided by the SaaS providing system 20. The system 10 may include at least one SaaS utilization apparatus that utilizes the SaaS provided by the SaaS providing system 20 in addition to the SaaS utilization apparatus 110. The SaaS utilization apparatus is used by a customer who utilizes the SaaS provided by the SaaS providing system 20. For example, the SaaS utilization apparatus may be constituted by an image forming apparatus such as a multifunction peripheral (MFP) or a computer such as a PC or tablet.

The system 10 includes a sender terminal 120 that is used by a sender. The sender is a person who makes an instruction to deliver an e-mail through the mail delivery system 30. The system 10 may include at least one sender terminal that is used by the sender in addition to the sender terminal 120. For example, the sender terminal may be constituted by a computer such as a PC or tablet.

The system 10 includes a customer terminal 130 that is used by the customer who utilizes the SaaS provided by the SaaS providing system 20. The system 10 may include at least one customer terminal that is used by the customer in addition to the customer terminal 130. For example, the customer terminal may be constituted by a computer such as a PC or tablet. The SaaS utilization apparatus may also serve as the customer terminal.

The system 10 includes an analyst terminal 140 that is used by an analyst. The system 10 may include at least one analyst terminal that is used by the analyst in addition to the analyst terminal 140. For example, the analyst terminal may be constituted by a computer such as a PC or tablet.

FIG. 2 is a block diagram of an example of the SaaS providing system 20 in a case where it is constituted by a single computer.

As shown in FIG. 2, the SaaS providing system 20 includes an operation unit 21, a display unit 22, a communication unit 23, a storage unit 24, and a control unit 25. The operation unit 21 is an operation device to which various operations are input, such as keyboard and mouse. The display unit 22 is a display device that displays various types of information, such as a liquid crystal display (LCD). The communication unit 23 is a communication device that communicates with an external apparatus via a network, such as a local area network (LAN) or Internet, or directly with a wire or wirelessly without the network. The storage unit 24 is a nonvolatile storage device that stores various types of information, such as a semiconductor memory or a hard disk drive (HDD). The control unit 25 comprehensively controls the SaaS providing system 20.

The storage unit 24 is capable of storing a SaaS providing program 24a for providing SaaS. For example, the SaaS providing program 24a may be installed in the SaaS providing system 20 during the production phase of the SaaS providing system 20. Alternatively, for example, the SaaS providing program 24a may be additionally installed in the SaaS providing system 20 from an external storage medium such as a universal serial bus (USB) memory. Alternatively, for example, the SaaS providing program 24a may be additionally installed in the SaaS providing system 20 from the network.

The storage unit 24 is capable of storing tenant management information 24b for managing tenants in the SaaS providing system 20.

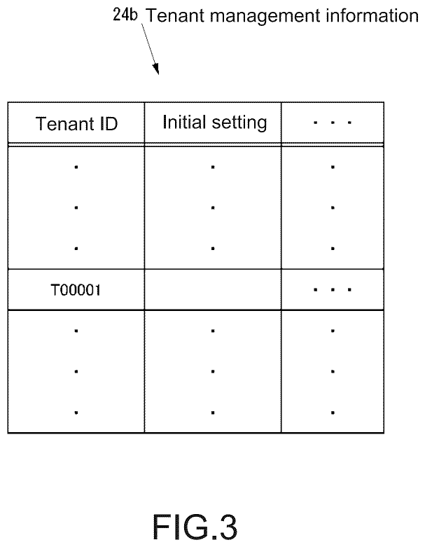

FIG. 3 is a diagram showing an example of the tenant management information 24b.

As shown in FIG. 3, the tenant management information 24b includes, for each tenant, a tenant ID that serves as identification information of the tenant and initial settings with respect to the tenant. The tenant management information 24b shown in FIG. 3 is depicted with some information omitted.

It should be noted that for example, the initial settings with respect to the tenant can be added by a manager of this tenant to be described later via a web site for this tenant. The web site for the tenant is provided by a SaaS providing unit 25a to be described later.

As shown in FIG. 2, the storage unit 24 is capable of storing tenant user management information 24c for managing users of the tenants (hereinafter, referred to as “tenant users”).

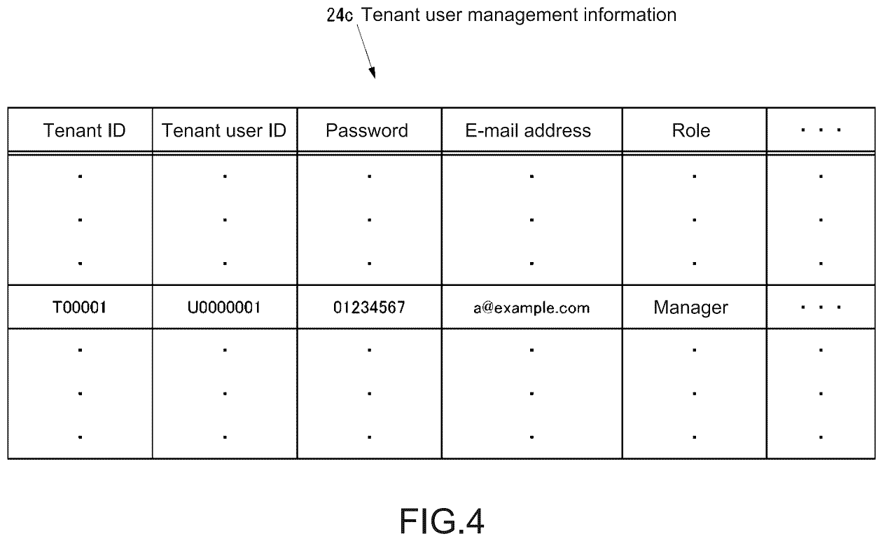

FIG. 4 is a diagram showing an example of the tenant user management information 24c.

As shown in FIG. 4, the tenant user management information 24c includes, for each tenant user, a tenant ID of the tenant to which the tenant user belongs, a tenant user ID that serves as identification information of the tenant user, a password of the tenant user, an e-mail address of the tenant user, and a role of the tenant user. For example, the role of the tenant user includes a manager of the tenant and a general user. The tenant user management information 24c shown in FIG. 4 is depicted with some information omitted.

It should be noted that, for example, the general user of the tenant can be added or deleted by the manager of this tenant via the web site for this tenant. As described above, the web site for the tenant is provided by the SaaS providing unit 25a to be described later.

As shown in FIG. 2, the storage unit 24 is capable of storing utilization history information 24d that indicates the general user's history of utilization of the SaaS.

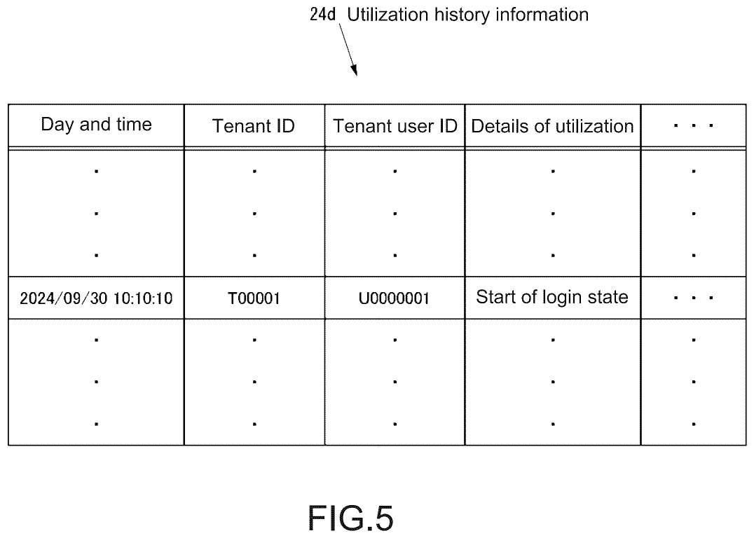

FIG. 5 is a diagram showing an example of the utilization history information 24d.

As shown in FIG. 5, the utilization history information 24d includes, for each utilization of the SaaS, date and time of the utilization of the SaaS, a tenant ID of the tenant to which a general user who has utilized the SaaS belongs, a tenant user ID of the general user who has utilized the SaaS, and the details of the utilization of the SaaS. For example, the details of the utilization of the SaaS include start and end of the general user's login state to the SaaS providing system 20 and the general user's utilization of any one function of the SaaS. The utilization history information 24d shown in FIG. 5 is depicted with some information omitted.

For example, the control unit 25 shown in FIG. 2 includes a central processing unit (CPU), a read only memory (ROM) that stores programs and various data, and a random access memory (RAM) as a memory used as a working area for the CPU of the control unit 25. The CPU of the control unit 25 executes the programs stored in the storage unit 24 or the ROM of the control unit 25.

The control unit 25 realizes the SaaS providing unit 25a that provides SaaS by executing the SaaS providing program 24a.

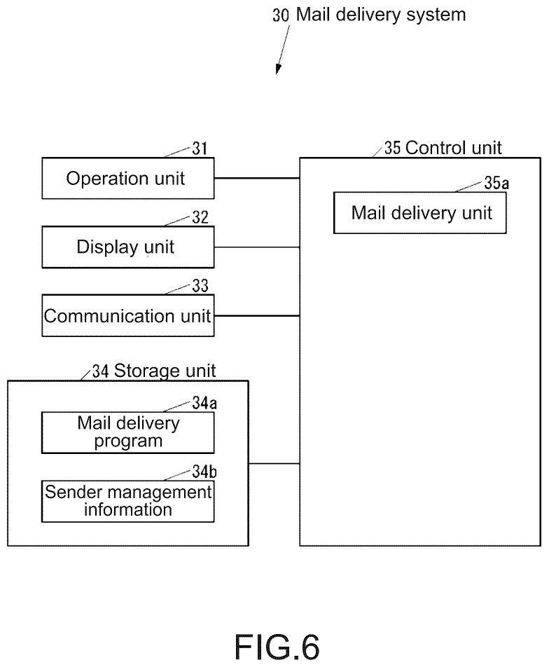

FIG. 6 is a block diagram of an example of the mail delivery system 30 in a case where it is constituted by a single computer.

As shown in FIG. 6, the mail delivery system 30 includes an operation unit 31, a display unit 32, a communication unit 33, a storage unit 34, and a control unit 35. The operation unit 31 is an operation device in which various operations are input, such as keyboard and mouse. The display unit 32 is a display device that displays various types of information, such as an LCD. The communication unit 33 is a communication device that communicates with an external apparatus via a network, such as a LAN or Internet, or directly with a wire or wirelessly via the network. The storage unit 34 is a nonvolatile storage device that stores various types of information, such as a semiconductor memory or HDD. The control unit 35 comprehensively controls the mail delivery system 30.

The storage unit 34 is capable of storing a mail delivery program 34a for delivering an e-mail. For example, the mail delivery program 34a may be installed in the mail delivery system 30 during the production phase of the mail delivery system 30. Alternatively, for example, the mail delivery program 34a may be additionally installed in the mail delivery system 30 from an external storage medium such as a USB memory. Alternatively, for example, the mail delivery program 34a may be additionally installed in the mail delivery system 30 from the network.

The storage unit 34 is capable of storing sender management information 34b for managing senders who make instructions to deliver e-mails to the mail delivery system 30.

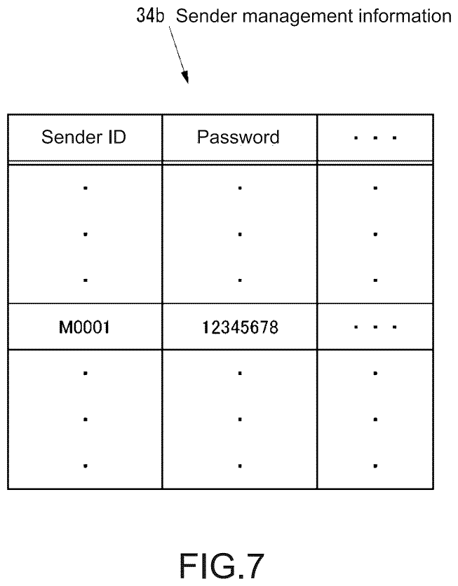

FIG. 7 is a diagram showing an example of the sender management information 34b.

As shown in FIG. 7, the sender management information 34b includes, for each sender, a sender ID that serves as identification information of the sender and a password of the sender. The sender management information 34b shown in FIG. 7 is depicted with some information omitted.

For example, the sender may be a person who conducts campaign to encourage customers to utilize the SaaS provided by the SaaS providing system 20. The sender may be a person who belongs to an organization that conducts customer success.

For example, the control unit 35 shown in FIG. 6 includes a CPU, a ROM that has stored programs and various data, and a RAM that serves as a memory used as a working area for the CPU of the control unit 35. The CPU of the control unit 35 executes the programs stored in the storage unit 34 or the ROM of the control unit 35.

The control unit 35 realizes a mail delivery unit 35a that delivers an e-mail by executing the mail delivery program 34a.

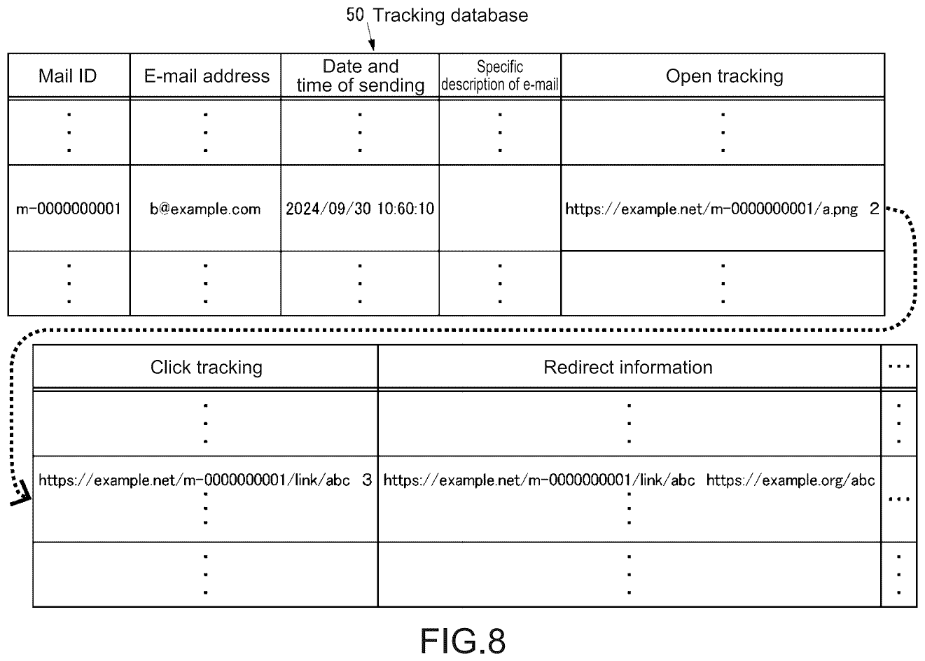

FIG. 8 is a diagram showing an example of the tracking database 50.

As shown in FIG. 8, the tracking database 50 includes, for each combination of e-mail and e-mail address, a mail ID that serves as identification information of the e-mail, an e-mail address that is a destination of the e-mail, date and time of sending the e-mail, specific description of the e-mail, such as subject and body of the e-mail, open tracking, click tracking for each link in the e-mail, and redirect information indicating a redirect destination of the link destination of the link in the e-mail. The tracking database 50 shown in FIG. 8 is depicted with some information omitted. For example, the tracking database 50 shown in FIG. 8 is depicted with the specific description of the e-mail omitted.

The open tracking includes a uniform resource locator (URL) of data (hereinafter, referred to as “open detection data”) for detecting opening of the e-mail by being read out when the e-mail delivered by the mail delivery system 30 is opened and the number of times by which the recipient has opened the e-mail delivered by the mail delivery system 30. In the example of the open tracking shown in FIG. 8, “https://example.net/m-0000000001/a.png” is the URL of the open detection data and “2” right next to “https://example.net/m-0000000001/a.png” is the number of times by which the recipient has opened the e-mail delivered by the mail delivery system 30.

The click tracking includes, for each link in the e-mail delivered by the mail delivery system 30, the URL of the link destination of the link in the e-mail delivered by the mail delivery system 30 and the number of clicks of the link in the e-mail delivered by the mail delivery system 30. In the example of the click tracking shown in FIG. 8, “https://example.net/m-0000000001/link/abc” is the URL of the link destination of the link in the e-mail and “3” right next to “https://example.net/m-0000000001/link/abc” is the number of clicks of the link corresponding to “https://example.net/m-0000000001/link/abc.”

The redirect information includes, for each URL of the link destination of the link in the e-mail delivered by the mail delivery system 30, the URL of the link destination of the link in the e-mail delivered by the mail delivery system 30 and the URL of the redirect destination. In the example of the redirect information shown in FIG. 8, “https://example.net/m-0000000001/link/abc” is the URL of the link destination of the link in the e-mail and “https://example.org/abc” right next to “https://example.net/m-0000000001/link/abc” is the URL of the redirect destination corresponding to “https://example.net/m-0000000001/link/abc.”

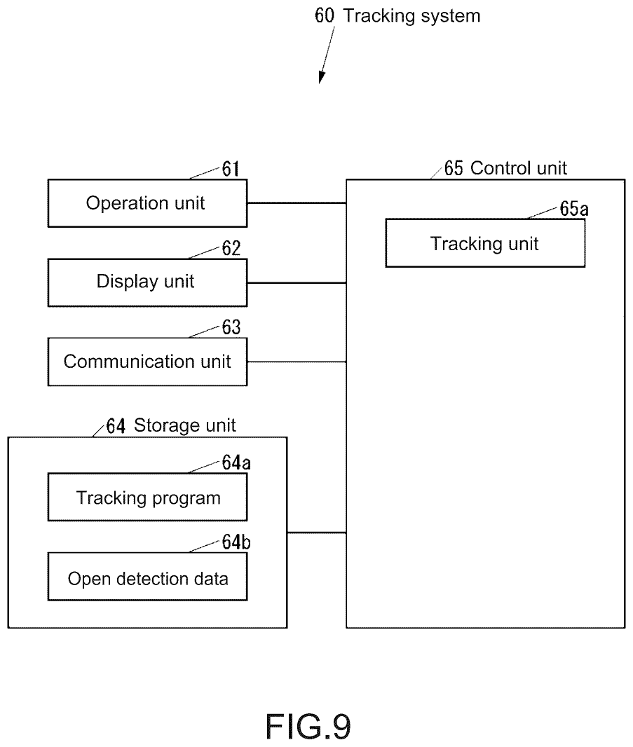

FIG. 9 is a block diagram of an example of the tracking system 60 in a case where it is constituted by a single computer.

As shown in FIG. 9, the tracking system 60 includes an operation unit 61, a display unit 62, a communication unit 63, a storage unit 64, and a control unit 65. The operation unit 61 is an operation device in which various operations are input, such as keyboard and mouse. The display unit 62 is a display device that displays various types of information, such as an LCD. The communication unit 63 is a communication device that communicates with an external apparatus via a network, such as a LAN or Internet, or directly with a wire or wirelessly via the network. The storage unit 64 is a nonvolatile storage device that stores various types of information, such as a semiconductor memory or HDD. The control unit 65 comprehensively controls the tracking system 60.

The storage unit 64 is capable of storing a tracking program 64a for tracking viewing of the e-mail delivered by the mail delivery system 30. For example, the tracking program 64a may be installed in the tracking system 60 during the production phase of the tracking system 60. Alternatively, for example, the tracking program 64a may be additionally installed in the tracking system 60 from an external storage medium such as a USB memory. Alternatively, for example, the tracking program 64a may be additionally installed in the tracking system 60 from the network.

The storage unit 64 is capable of storing open detection data 64b. For example, the open detection data is image data.

For example, the control unit 65 includes a CPU, a ROM that stores programs and various data, and a RAM that serves as a memory used as a working area for the CPU of the control unit 65. The CPU of the control unit 65 executes the programs stored in the storage unit 64 or the ROM of the control unit 65.

The control unit 65 realizes a tracking unit 65a that tracks views of the e-mail delivered by the mail delivery system 30 by executing the tracking program 64a.

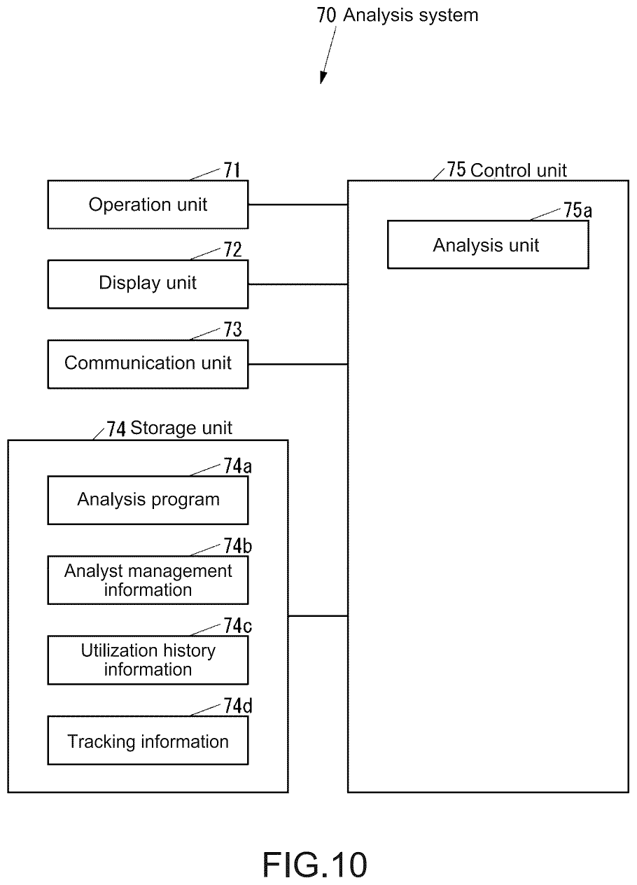

FIG. 10 is a block diagram of an example of the analysis system 70 in a case where it is constituted by a single computer.

As shown in FIG. 10, the analysis system 70 includes an operation unit 71, a display unit 72, a communication unit 73, a storage unit 74, and a control unit 75. The operation unit 71 is an operation device in which various operations are input, such as keyboard and mouse. The display unit 72 is a display device that displays various types of information, such as an LCD. The communication unit 73 is a communication device that communicates with an external apparatus via a network, such as a LAN or Internet, or directly with a wire or wirelessly via the network. The storage unit 74 is a nonvolatile storage device that stores various types of information, such as a semiconductor memory or HDD. The control unit 75 comprehensively controls the analysis system 70.

The storage unit 74 is capable of storing an analysis program 74a for executing the analysis according to the KPI on the basis of the data indicating the utilization status of the SaaS providing system 20 and the tracking data. For example, the analysis program 74a may be installed in the analysis system 70 during the production phase of the analysis system 70. Alternatively, for example, the analysis program 74a may be additionally installed in the analysis system 70 from an external storage medium such as a USB memory. Alternatively, for example, the analysis program 74a may be additionally installed in the analysis system 70 from the network.

The storage unit 74 is capable of storing analyst management information 74b for managing analysts who execute the analysis according to the KPI on the basis of the data indicating the utilization status of the SaaS providing system 20 and the tracking data.

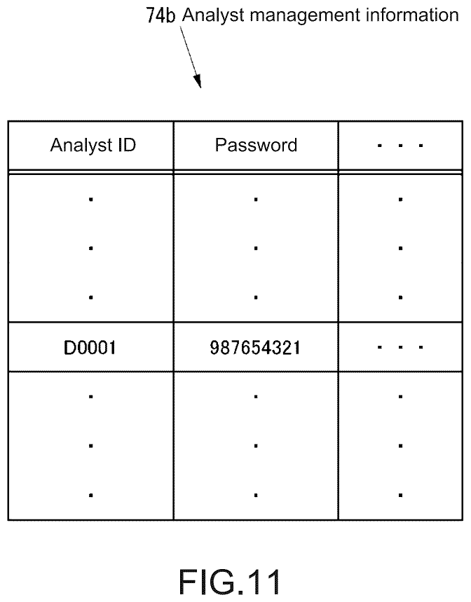

FIG. 11 is a diagram showing an example of the analyst management information 74b.

As shown in FIG. 11, the analyst management information 74b includes, for each analyst, an analyst ID that serves as identification information of the analyst and a password of the analyst. The analyst management information 74b shown in FIG. 11 is depicted with some information omitted.

For example, the sender may also serve as the analyst.

As shown in FIG. 10, the storage unit 74 is capable of storing utilization history information 74c indicating the general user's history of utilization of the SaaS. A configuration of the utilization history information 74c is similar to the configuration of the utilization history information 24d (see FIG. 5).

The storage unit 74 is capable of storing tracking information 74d that serves as a database that stores tracking data indicating a status in which a recipient of the e-mail delivered by the mail delivery system 30 is viewing this e-mail. A configuration of the tracking information 74d is similar to the configuration of the tracking database 50 (see FIG. 8).

For example, the control unit 75 includes a CPU, a ROM that stores programs and various data, and a RAM that serves as a memory used as a working area for the CPU of the control unit 75. The CPU of the control unit 75 executes the programs stored in the storage unit 74 or the ROM of the control unit 75.

The control unit 75 realizes an analysis unit 75a that executes the analysis according to the KPI on the basis of the data indicating the utilization status of the SaaS providing system 20 and the tracking data by executing the analysis program 74a.

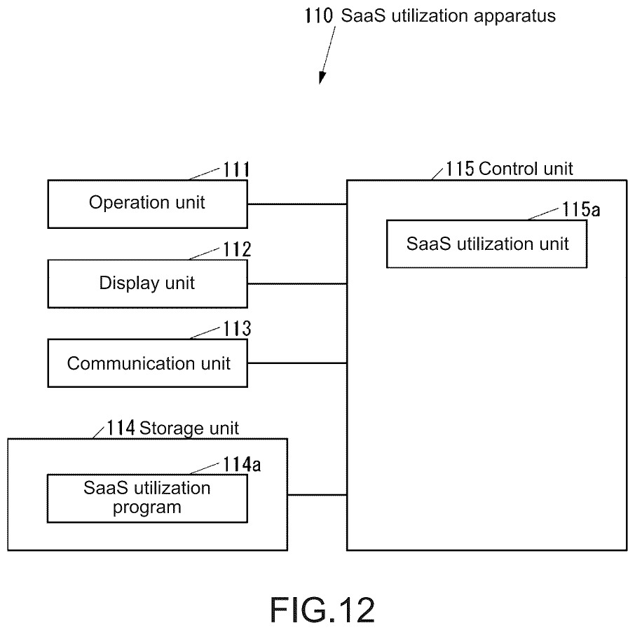

FIG. 12 is a block diagram of an example of the SaaS utilization apparatus 110.

As shown in FIG. 12, the SaaS utilization apparatus 110 includes an operation unit 111, a display unit 112, a communication unit 113, a storage unit 114, and a control unit 115. The operation unit 111 is an operation device in which various operations are input, such as keyboard and mouse. The display unit 112 is a display device that displays various types of information, such as an LCD. The communication unit 113 is a communication device that communicates with an external apparatus via a network, such as a LAN or Internet, or directly with a wire or wirelessly via the network. The storage unit 114 is a nonvolatile storage device that stores various types of information, such as a semiconductor memory or HDD. The control unit 115 comprehensively controls the SaaS utilization apparatus 110.

The storage unit 114 is capable of storing a SaaS utilization program 114a that serves as a program for utilizing the SaaS provided by the SaaS providing system 20. For example, the SaaS utilization program 114a may be installed in the SaaS utilization apparatus 110 during the production phase of the SaaS utilization apparatus 110. Alternatively, for example, the SaaS utilization program 114a may be additionally installed in the SaaS utilization apparatus 110 from an external storage medium such as a USB memory. Alternatively, for example, the SaaS utilization program 114a may be additionally installed in the SaaS utilization apparatus 110 from the network.

For example, the control unit 115 includes a CPU, a ROM that has stored programs and various data, and a RAM that serves as a memory used as a working area for the CPU of the control unit 115. The CPU of the control unit 115 executes the programs stored in the storage unit 114 or the ROM of the control unit 115.

The control unit 115 realizes a SaaS utilization unit 115a that utilizes the SaaS provided by the SaaS providing system 20 by executing the SaaS utilization program 114a.

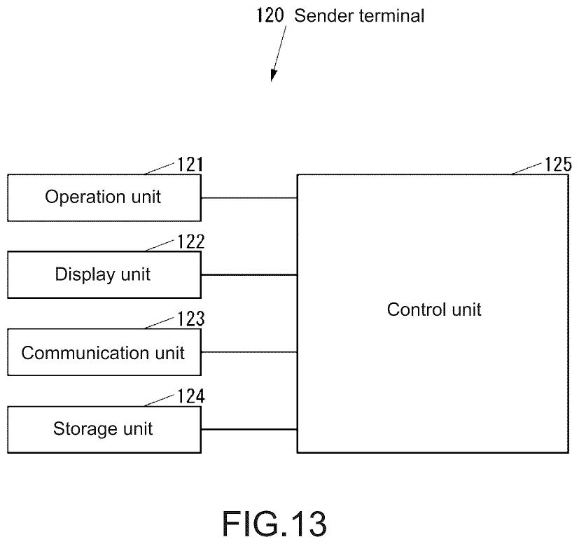

FIG. 13 is a block diagram of an example of the sender terminal 120.

As shown in FIG. 13, the sender terminal 120 includes an operation unit 121, a display unit 122, a communication unit 123, a storage unit 124, and a control unit 125. The operation unit 121 is an operation device in which various operations are input, such as keyboard and mouse. The display unit 122 is a display device that displays various types of information, such as an LCD. The communication unit 123 is a communication device that communicates with an external apparatus via a network, such as a LAN or Internet, or directly with a wire or wirelessly via the network. The storage unit 124 is a nonvolatile storage device that stores various types of information, such as a semiconductor memory or HDD. The control unit 125 comprehensively controls the sender terminal 120.

For example, the control unit 125 includes a CPU, a ROM that has stored programs and various data, and a RAM that serves as a memory used as a working area for the CPU of the control unit 125. The CPU of the control unit 125 executes the programs stored in the storage unit 124 or the ROM of the control unit 125.

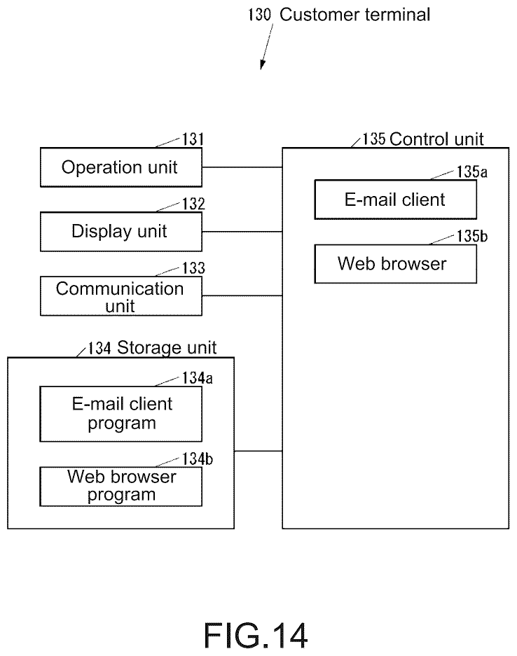

FIG. 14 is a block diagram of an example of the customer terminal 130.

As shown in FIG. 14, the customer terminal 130 includes an operation unit 131, a display unit 132, a communication unit 133, a storage unit 134, and a control unit 135. The operation unit 131 is an operation device in which various operations are input, such as keyboard and mouse. The display unit 132 is a display device that displays various types of information, such as an LCD. The communication unit 133 is a communication device that communicates with an external apparatus via a network, such as a LAN or Internet, or directly with a wire or wirelessly via the network. The storage unit 134 is a nonvolatile storage device that stores various types of information, such as a semiconductor memory or HDD. The control unit 135 comprehensively controls the customer terminal 130.

The storage unit 134 is capable of storing an e-mail client program 134a that serves as a program for an e-mail client. For example, the e-mail client program 134a may be installed in the customer terminal 130 during the production phase of the customer terminal 130. Alternatively, for example, the e-mail client program 134a may be additionally installed in the customer terminal 130 from an external storage medium such as a USB memory. Alternatively, for example, the e-mail client program 134a may be additionally installed in the customer terminal 130 from the network.

The storage unit 134 is capable of storing a web browser program 134b that serves as a program for the web browser. For example, the web browser program 134b may be installed in the customer terminal 130 during the production phase of the customer terminal 130. Alternatively, for example, the web browser program 134b may be additionally installed in the customer terminal 130 from an external storage medium such as a USB memory. Alternatively, for example, the web browser program 134b may be additionally installed in the customer terminal 130 from the network.

For example, the control unit 135 includes a CPU, a ROM that stores programs and various data, and a RAM that serves as a memory used as a working area for the CPU of the control unit 135. The CPU of the control unit 135 executes the programs stored in the storage unit 134 or the ROM of the control unit 135.

The control unit 135 realizes an e-mail client 135a by executing the e-mail client program 134a.

The control unit 135 realizes a web browser 135b by executing the web browser program 134b.

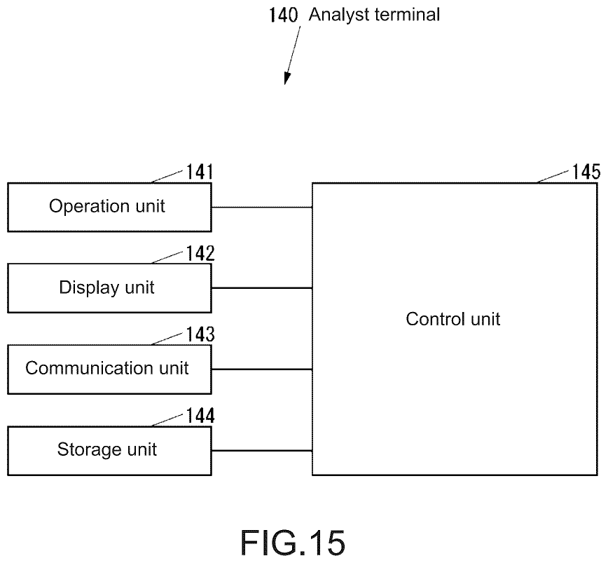

FIG. 15 is a block diagram of an example of the analyst terminal 140.

As shown in FIG. 12, the analyst terminal 140 includes an operation unit 141, a display unit 142, a communication unit 143, a storage unit 144, and a control unit 145. The operation unit 141 is an operation device in which various operations are input, such as keyboard and mouse. The display unit 142 is a display device that displays various types of information, such as an LCD. The communication unit 143 is a communication device that communicates with an external apparatus via a network, such as a LAN or Internet, or directly with a wire or wirelessly via the network. The storage unit 144 is a nonvolatile storage device that stores various types of information, such as a semiconductor memory or HDD. The control unit 145 comprehensively controls the analyst terminal 140.

For example, the control unit 145 includes a CPU, a ROM that stores programs and various data, and a RAM that serves as a memory used as a working area for the CPU of the control unit 145. The CPU of the control unit 145 executes the programs stored in the storage unit 144 or the ROM of the control unit 145.

By the way, in a technology in the related art, there is a problem in that it is difficult to promote the utilization of the SaaS by using an e-mail. It should be noted that the SaaS is the abbreviation of software as a service and refers to a service that permits utilization of software provided by a vendor on a cloud server. In the present disclosure, the SaaS also includes an application provided on the cloud server.

In view of this, it is an objective of the present disclosure to provide an analysis system, a system, an information processing apparatus, and an analysis program storage medium that make it possible to enhance an effect of promoting the utilization of the SaaS by using an e-mail.

Next, an operation of the system 10 will be described.

Hereinafter, the SaaS utilization apparatus 110 will be described, representing the SaaS utilization apparatus. Similarly, the sender terminal 120, the customer terminal 130, and the analyst terminal 140 will be described, representing the sender terminal, the customer terminal, and the analyst terminal, respectively.

First of all, an operation of the system 10 in a case of sending an e-mail in accordance with a phase of utilization of the customer with respect to the SaaS provided by the SaaS providing system 20 will be described.

The phase of utilization of the customer with respect to the SaaS provided by the SaaS providing system 20 includes first to fourth phases. The first phase is a phase where a customer makes a contract for utilizing the SaaS with a provider of the SaaS. The second phase is a phase where a manager on the customer side is registered in the SaaS providing system 20 in order for the customer to utilize the SaaS. The third phase is a phase where necessary initial settings are executed or a general user on the customer side is registered in the SaaS providing system 20 in order for the customer to utilize the SaaS. The fourth phase is a phase where the customer utilizes the SaaS. The contract made between the customer and the provider of the SaaS is a contract for continuously utilizing the SaaS, such as a subscription contract.

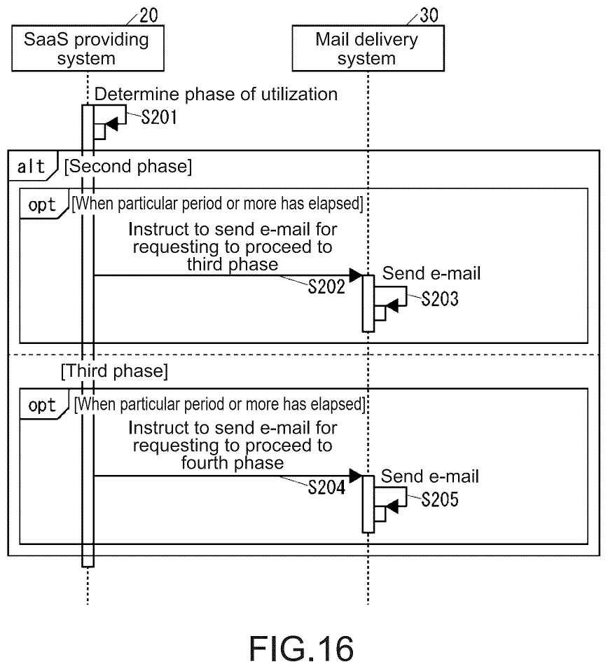

FIG. 16 is a sequence diagram of an operation of the system 10 in a case of sending an e-mail in accordance with a phase of utilization of the customer with respect to the SaaS provided by the SaaS providing system 20.

As shown in FIG. 16, the SaaS providing unit 25a of the SaaS providing system 20 determines a phase of utilization of the customer (S201). For example, the SaaS providing unit 25a may determine a phase of utilization of a customer who is a target of a tenant determined by a tenant ID for which no manager is associated in the tenant user management information 24c, as the first phase. Moreover, the SaaS providing unit 25a may determine a phase of utilization of a customer who is a target of a tenant determined by a tenant ID for which a manager is associated in the tenant user management information 24c, but no general user is associated with this manager in the tenant user management information 24c, as the second phase. Moreover, the SaaS providing unit 25a may determine a phase of utilization of a customer who is a target of a tenant determined by a tenant ID for which a manager is associated in the tenant user management information 24c, but no initial settings are associated in the tenant management information 24b, as the second phase. Moreover, the SaaS providing unit 25a may determine a phase of utilization of a customer who is a target of a tenant determined by a tenant ID for which a general user is associated in the tenant user management information 24c and initial settings are associated in the tenant management information 24b, but no history of utilization of the SaaS is associated in the utilization history information 24d, as the third phase. Moreover, the SaaS providing unit 25a may determine a phase of utilization of a customer who is a target of a tenant determined by a tenant ID for which a history of utilization of the SaaS is associated in the utilization history information 24d, as the fourth phase.

In a case where the SaaS providing unit 25a determines in S201 that the phase of utilization of the customer is the second phase, when a particular period or more has elapsed since the SaaS providing unit 25a first determined that the phase of utilization of the customer is the second phase, the SaaS providing unit 25a instructs the mail delivery system 30 to send an e-mail to the e-mail address associated with the tenant user ID of this manager in the tenant user management information 24c (S202). Here, the e-mail is for requesting the manager of this customer to proceed the phase of utilization of the customer to the third phase.

When the mail delivery unit 35a of the mail delivery system 30 receives the instruction in S202, the mail delivery unit 35a of the mail delivery system 30 sends the e-mail instructed in S202 (S203).

In a case where the SaaS providing unit 25a determines in S201 that the phase of utilization of the customer is the third phase, when a particular period or more has elapsed since the SaaS providing unit 25a first determined that the phase of utilization of the customer is the third phase, the SaaS providing unit 25a instructs the mail delivery system 30 to send an e-mail to the e-mail address associated with the tenant user ID of this manager in the tenant user management information 24c (S204). Here, the e-mail is for requesting the manager of this customer to proceed the phase of utilization of the customer to the fourth phase.

When the mail delivery unit 35a of the mail delivery system 30 receives the instruction in S204, the mail delivery unit 35a of the mail delivery system 30 sends the e-mail instructed in S204 (S205).

It should be noted that the delivery of the e-mail in a case where the phase of utilization of the customer is the fourth phase will be described later.

Next, an operation of the system 10 in a case where the general user logs in the SaaS providing system 20 will be described.

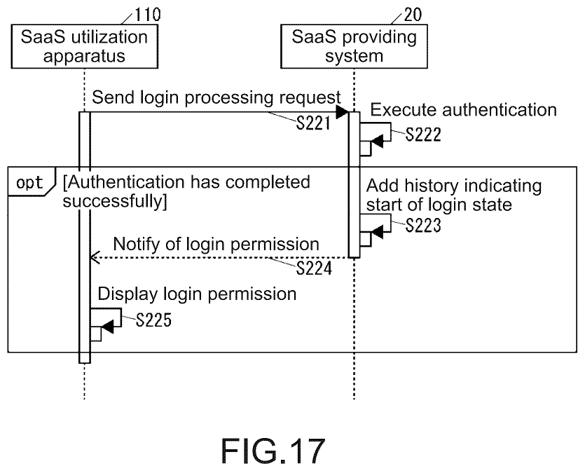

FIG. 17 is a sequence diagram of an operation of the system 10 in a case where the general user logs in the SaaS providing system 20.

The general user can instruct the SaaS utilization apparatus 110 to log in the SaaS providing system 20 via the operation unit 111 of the SaaS utilization apparatus 110. When the SaaS utilization unit 115a of the SaaS utilization apparatus 110 is instructed to log in the SaaS providing system 20, the SaaS utilization unit 115a of the SaaS utilization apparatus 110 sends a request to execute login processing (hereinafter, referred to as “login processing request”) to the SaaS providing system 20 as shown in FIG. 17 (S221). The SaaS utilization unit 115a of the SaaS utilization apparatus 110 includes a combination of the tenant ID, the tenant user ID, and the password, which are input from the operation unit 111 of the SaaS utilization apparatus 110, in the login processing request.

When the SaaS providing unit 25a of the SaaS providing system 20 receives the login processing request sent in S221, the SaaS providing unit 25a of the SaaS providing system 20 executes authentication on the basis of the combination of the tenant ID, the tenant user ID, and the password, which is included in the received login processing request, and the tenant user management information 24c (S222). Specifically, the SaaS providing unit 25a determines that the authentication has completed successfully in a case where the combination of the tenant ID, the tenant user ID, and the password, which is included in the login processing request sent S221, is included in the tenant user management information 24c. On the other hand, the SaaS providing unit 25a determines that the authentication has failed in a case where the combination of the tenant ID, the tenant user ID, and the password, which is included in the login processing request sent in S221, is not included in the tenant user management information 24c.

In a case where the SaaS providing unit 25a determines in S222 that the authentication has completed successfully, the SaaS providing unit 25a adds a history indicating the start of the login state of the general user for which the authentication has completed successfully to the utilization history information 24d (S223).

When the processing in S223 ends, the SaaS providing unit 25a notifies the SaaS utilization apparatus 110 of the login permission (S224).

When the SaaS utilization unit 115a of the SaaS utilization apparatus 110 receives the notification in S224, the SaaS utilization unit 115a of the SaaS utilization apparatus 110 displays that the login has been permitted on the display unit 112 of the SaaS utilization apparatus 110 (S225).

Next, an operation of the system 10 in a case where the general user utilizes the SaaS will be described.

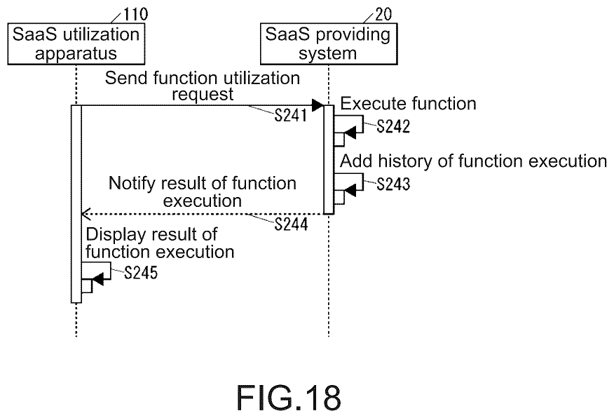

FIG. 18 is a sequence diagram of an operation of the system 10 in a case where the general user utilizes the SaaS.

In a case where the general user has logged into the SaaS providing system 20, i.e., the general user is in a login state, the general user can instruct the SaaS utilization apparatus 110 to utilize a particular function of the SaaS provided by the SaaS providing system 20 via the operation unit 111 of the SaaS utilization apparatus 110. When the SaaS utilization unit 115a of the SaaS utilization apparatus 110 is instructed to utilize the particular function of the SaaS provided by the SaaS providing system 20, the SaaS utilization unit 115a of the SaaS utilization apparatus 110 sends a request to utilize the particular function of the SaaS provided by the SaaS providing system 20 (hereinafter, referred to as “function utilization request”) to the SaaS providing system 20 as shown in FIG. 18 (S241).

When the SaaS providing unit 25a of the SaaS providing system 20 receives the function utilization request sent in S241, the SaaS providing unit 25a of the SaaS providing system 20 executes the function according to the received function utilization request (S242).

When the processing in S242 ends, the SaaS providing unit 25a adds a history of execution of the function in S242 to the utilization history information 24d (S243).

When the processing in S243 ends, the SaaS providing unit 25a notifies the SaaS utilization apparatus 110 of a result of the execution of the function in S242 (S244).

When the SaaS utilization unit 115a of the SaaS utilization apparatus 110 receives the notification in S244, the SaaS utilization unit 115a of the SaaS utilization apparatus 110 displays the result of the execution of the function, which is notified in S244, on the display unit 112 of the SaaS utilization apparatus 110 (S245).

Next, an operation of the system 10 in a case where the general user logs out of the SaaS providing system 20 will be described.

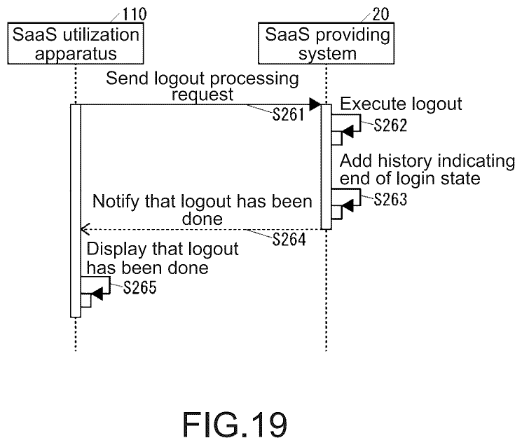

FIG. 19 is a sequence diagram of an operation of the system 10 in a case where the general user logs out of the SaaS providing system 20.

The general user can instruct the SaaS utilization apparatus 110 to log out of the SaaS providing system 20 via the operation unit 111 of the SaaS utilization apparatus 110. When the SaaS utilization unit 115a of the SaaS utilization apparatus 110 is instructed to log out of the SaaS providing system 20, the SaaS utilization unit 115a of the SaaS utilization apparatus 110 sends a request of execution of logout processing (hereinafter, referred to as “logout processing request”) to the SaaS providing system 20 as shown in FIG. 19 (S261).

When the SaaS providing unit 25a of the SaaS providing system 20 receives the logout processing request sent in S261, the SaaS providing unit 25a of the SaaS providing system 20 executes the logout of the general user who is a target of the logout processing request (S262).

When the processing in S262 ends, the SaaS providing unit 25a adds a history indicating the end of the login state of the general user who is the target of the logout processing request sent in S261 to the utilization history information 24d (S263).

When the processing in S263 ends, the SaaS providing unit 25a notifies the SaaS utilization apparatus 110 that the general user has logged out (S264).

When the SaaS utilization unit 115a of the SaaS utilization apparatus 110 receives the notification in S264, the SaaS utilization unit 115a of the SaaS utilization apparatus 110 displays that the general user has logged out on the display unit 112 of the SaaS utilization apparatus 110 (S265).

Next, an operation of the analysis system 70 in a case of collecting the utilization history information from the SaaS providing system 20 will be described.

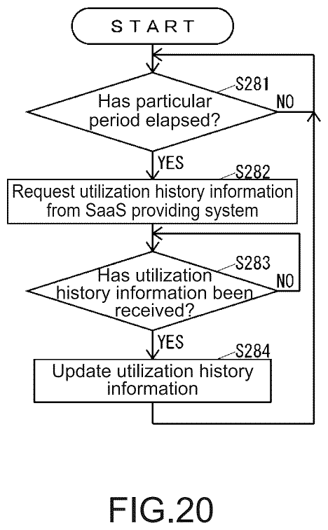

FIG. 20 is a flowchart of an operation of the analysis system 70 in a case of collecting the utilization history information from the SaaS providing system 20.

As shown in FIG. 20, the analysis unit 75a of the analysis system 70 determines whether or not a particular period has elapsed since the last update of the utilization history information 74c until the analysis unit 75a of the analysis system 70 determines that the particular period has elapsed since the last update of the utilization history information 74c (S281). It should be noted that in a case where the analysis unit 75a has not yet updated the utilization history information 74c even once, the analysis unit 75a treats the lapse of the particular period from the start of the operation shown in FIG. 20 as the lapse of the particular period since the last update of the utilization history information 74c.

When the analysis unit 75a determines in S281 that the particular period has elapsed since the last update of the utilization history information 74c, the analysis unit 75a requests the utilization history information from the SaaS providing system 20 (S282). When the SaaS providing unit 25a of the SaaS providing system 20 receives the request in S282, the SaaS providing unit 25a of the SaaS providing system 20 sends utilization history information identical to the utilization history information 24d to the analysis system 70.

The analysis unit 75a of the analysis system 70 determines whether or not the analysis unit 75a has received the utilization history information from the SaaS providing system 20 until the analysis unit 75a determines that the analysis unit 75a has received the utilization history information from the SaaS providing system 20 after the processing in S282 (S283).

When the analysis unit 75a determines in S283 that the analysis unit 75a has received the utilization history information from the SaaS providing system 20, the analysis unit 75a updates (S284) the utilization history information 74c by using the utilization history information received from the SaaS providing system 20 and executes the processing in S281.

Next, an operation of the system 10 in a case of delivering an e-mail in accordance with an instruction made by the sender will be described.

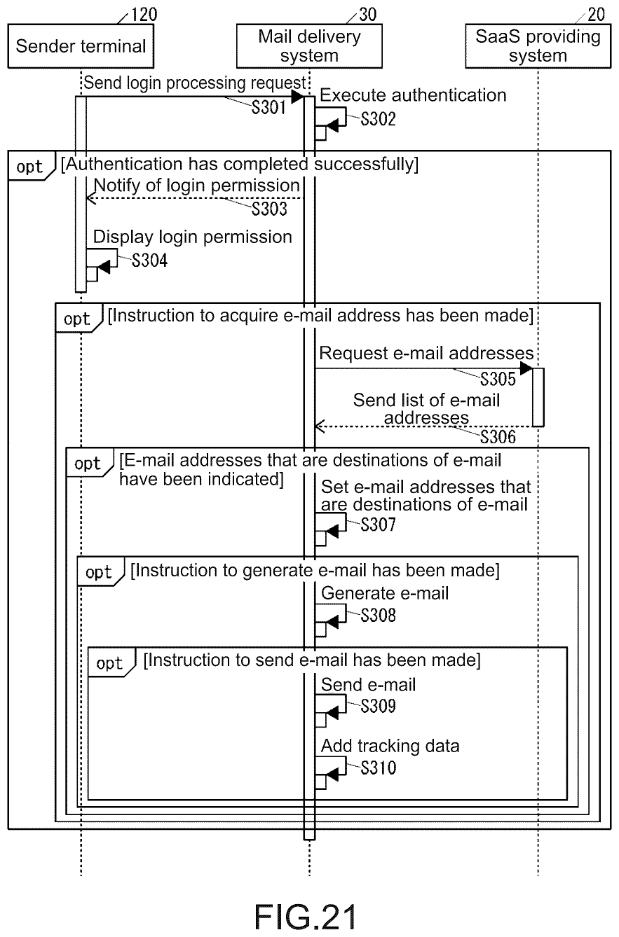

FIG. 21 is a sequence diagram of an operation of the system 10 in a case of delivering an e-mail in accordance with an instruction made by the sender.

The sender can instruct the sender terminal 120 to log in the mail delivery system 30 via the operation unit 121 of the sender terminal 120. When the control unit 125 of the sender terminal 120 is instructed to log in the mail delivery system 30, the control unit 125 of the sender terminal 120 sends a login processing request to the mail delivery system 30 as shown in FIG. 21 (S301). The control unit 125 of the sender terminal 120 includes a combination of the sender ID and the password, which is input from the operation unit 121 of the sender terminal 120, is included in the login processing request.

When the mail delivery unit 35a of the mail delivery system 30 receives the login processing request sent in S301, the mail delivery unit 35a of the mail delivery system 30 executes authentication on the basis of the combination of the sender ID and the password, which is included in the received login processing request, and the sender management information 34b (S302). Specifically, the mail delivery unit 35a determines that the authentication has completed successfully in a case where the combination of the sender ID and the password, which is included in the login processing request sent S301, is included in the sender management information 34b. On the other hand, the mail delivery unit 35a determines that the authentication has failed in a case where the combination of the sender ID and the password, which is included in the login processing request sent S301, is not included in the sender management information 34b.

In a case where the mail delivery unit 35a determines in S302 that the authentication has completed successfully, the mail delivery unit 35a notifies the sender terminal 120 of the login permission (S303).

When the control unit 125 of the sender terminal 120 receives the notification in S303, the control unit 125 of the sender terminal 120 displays that the login has been permitted on the display unit 122 of the sender terminal 120 (S304).

In a case where the sender has logged into the mail delivery system 30, the sender can instruct the mail delivery system 30 to acquire candidates of e-mail addresses that are destinations of the e-mail delivered by the mail delivery system 30 via the sender terminal 120. When the mail delivery unit 35a of the mail delivery system 30 is instructed to acquire the e-mail addresses that are the destinations of the e-mail delivered by the mail delivery system 30, the mail delivery unit 35a of the mail delivery system 30 requests the e-mail addresses from the SaaS providing system 20 (S305).

When the SaaS providing unit 25a of the SaaS providing system 20 receives the request in S305, the SaaS providing unit 25a of the SaaS providing system 20 sends a list of e-mail addresses indicated by the sender management information 34b to the mail delivery system 30 (S306).

On the basis of the list of e-mail addresses sent from the SaaS providing system 20 in S306, the sender is capable of indicating the e-mail addresses that are the destinations of the e-mail delivered by the mail delivery system 30 to the mail delivery system 30 via the sender terminal 120. Specifically, the sender may set the e-mail addresses included in the list sent from the SaaS providing system 20 in S306 as they are as the e-mail addresses that are the destinations of the e-mail delivered by the mail delivery system 30. Alternatively, the sender may delete at least some e-mail addresses from the e-mail addresses included in the list sent from the SaaS providing system 20 in S306 or newly add an e-mail address(es) to the list and set them as the e-mail addresses that are the destinations of the e-mail delivered by the mail delivery system 30. When the e-mail addresses that are the destinations of the e-mail are indicated to the mail delivery unit 35a of the mail delivery system 30, the mail delivery unit 35a of the mail delivery system 30 sets the e-mail addresses that are the destinations of the e-mail delivered by the mail delivery system 30 as indicated by the sender (S307).

The sender can instruct the mail delivery system 30 to generate the e-mail delivered by the mail delivery system 30 via the sender terminal 120. Specifically, the sender can select any one of templates stored in the template database 40 and generating an e-mail using the selected template. The sender may generate an e-mail without any template. When the mail delivery unit 35a of the mail delivery system 30 is instructed to generate the e-mail, the mail delivery unit 35a of the mail delivery system 30 generates the e-mail as instructed (S308). Here, the mail delivery unit 35a sets a URL indicating the open detection data 64b in the tracking system 60 as the URL of the open detection data in the e-mail to be generated in S308. Moreover, the mail delivery unit 35a sets a URL in the tracking system 60 as the URL of the link in the e-mail to be generated in S308. The mail delivery unit 35a makes the URL of the open detection data in the e-mail to be generated in S308 and the URL of the link in the e-mail to be generated in S308 different for each combination of e-mail and e-mail address.

When the processing in S308 ends, the sender can instruct the mail delivery system 30 to send the e-mail generated in S308 via the sender terminal 120. When the mail delivery unit 35a of the mail delivery system 30 is instructed to send the e-mail, the mail delivery unit 35a of the mail delivery system 30 sends the e-mail generated in S308 to the e-mail addresses set in S307 (S309).

When the processing in S309 ends, the mail delivery unit 35a of the mail delivery system 30 adds the tracking data of the e-mail sent in S309 to the tracking database 50 for each of the e-mail addresses that are the destinations of the e-mail sent in S309 (S310).

In the operation shown in FIG. 21, the mail delivery system 30 acquires the e-mail addresses from the SaaS providing system 20. However, the mail delivery system 30 does not need to acquire the e-mail addresses from the SaaS providing system 20. For example, the sender may input the e-mail addresses that are the destinations of the generated e-mail to the mail delivery system 30.

Next, an operation of the system 10 in a case where the customer opens the e-mail delivered by the mail delivery system 30 will be described.

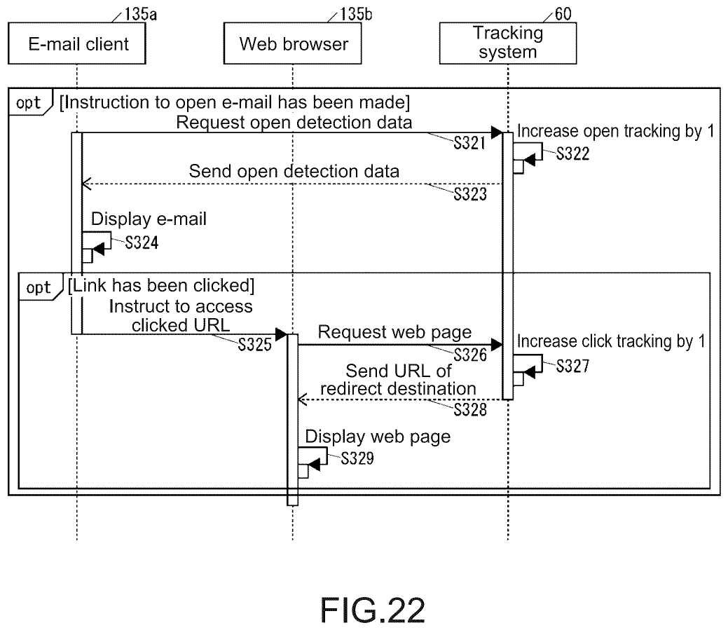

FIG. 22 is a sequence diagram of an operation of the system 10 in a case where the customer opens the e-mail delivered by the mail delivery system 30.

After receiving the e-mail delivered to his or her own e-mail address by the mail delivery system 30 through the e-mail client 135a of the customer terminal 130, the customer, i.e., the manager or the general user of the tenant, can instruct the e-mail client 135a to open the received e-mail via the operation unit 131 of the customer terminal 130. When the e-mail client 135a is instructed to open the e-mail, the e-mail client 135a requests the open detection data, which is determined by the URL of the open detection data included in this e-mail, from the tracking system 60 (S321).

When the tracking unit 65a of the tracking system 60 receives the request in S321, the tracking unit 65a of the tracking system 60 increases the open tracking, which is associated with the URL accessed in S321 in the tracking database 50, by 1 (S322).

When the processing in S322 ends, the tracking unit 65a sends the open detection data that is a target of the request in S321 to the e-mail client 135a (S323).

When the processing in S323 ends, the e-mail client 135a displays the contents of the e-mail on the display unit 132, using the open detection data sent in S323 (S324).

In a case where the e-mail is displayed on the display unit 132 in S324, the customer can click on the link in this e-mail in accordance with the customer's own interest. When the link in the e-mail is clicked, the e-mail client 135a instructs the web browser 135b to access the URL of the clicked link (S325).

When the web browser 135b receives the instruction in S325, the web browser 135b requests a webpage, which is determined by the URL according to the instruction in S325, from the tracking system 60 (S326).

When the tracking unit 65a of the tracking system 60 receives the request in S326, the tracking unit 65a of the tracking system 60 increases click tracking, which is associated with the URL accessed in S326 in the tracking database 50, by 1 (S327).

When the processing in S327 ends, the tracking unit 65a sends the URL of the redirect destination, which is associated in the URL that is a target of the request in S326 with the redirect information of the tracking database 50, to the web browser 135b (S328).

When the web browser 135b receives the URL sent in S328, the web browser 135b displays the webpage determined by the received URL on the display unit 132 (S329).

Next, an operation of the analysis system 70 in a case of collecting the tracking data from the tracking database 50 will be described.

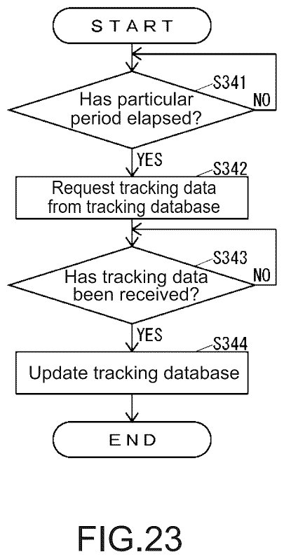

FIG. 23 is a flowchart of the operation of the analysis system 70 in a case of collecting the tracking data from the tracking database 50.

As shown in FIG. 23, the analysis unit 75a of the analysis system 70 determines whether or not a particular period has elapsed since the last update of the tracking information 74d until the analysis unit 75a of the analysis system 70 determines that the particular period has elapsed since the last update of the tracking information 74d (S341). It should be noted that in a case where the analysis unit 75a has not yet updated the tracking information 74d even once, the analysis unit 75a treats the lapse of the particular period from the start of the operation shown in FIG. 23 as the lapse of the particular period since the last update of the tracking information 74d.

When the analysis unit 75a determines in S341 that the particular period has elapsed since the last update of the tracking information 74d, the analysis unit 75a requests tracking data from the tracking database 50 (S342). When the tracking database 50 receives the request in S342, the tracking database 50 sends the tracking data of the tracking database 50 to the analysis system 70.

The analysis unit 75a of the analysis system 70 determines whether or not the analysis unit 75a of the analysis system 70 has received the tracking data from the tracking database 50 until the analysis unit 75a of the analysis system 70 determines that the analysis unit 75a of the analysis system 70 has received the tracking data from the tracking database 50 after the processing in S342 (S343).

When the analysis unit 75a determines in S343 that the analysis unit 75a has received the tracking data from the tracking information 74d, the analysis unit 75a updates (S344) the tracking information 74d in the tracking data received from the tracking information 74d and executes the processing in S341.

Next, an operation of the system 10 in a case where the analysis system 70 analyzes data in accordance with an instruction made by the analyst will be described.

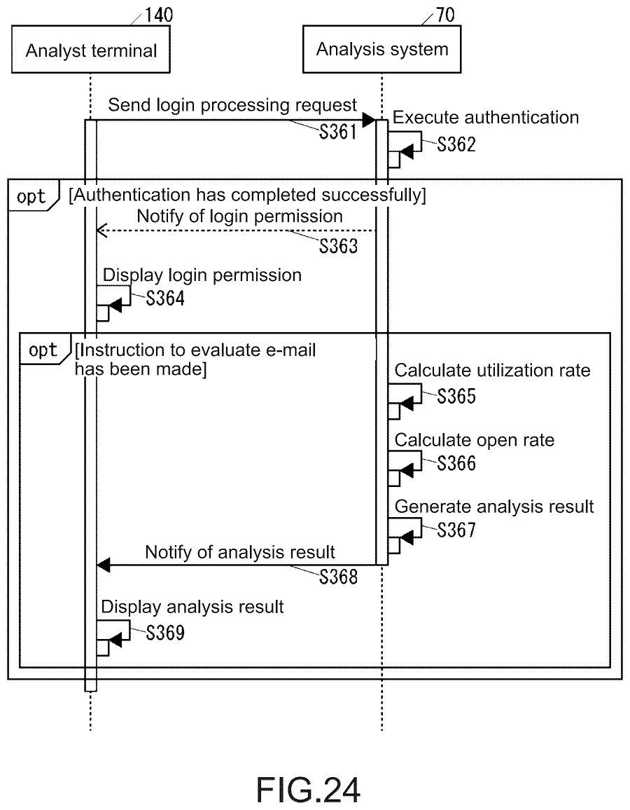

FIG. 24 is a sequence diagram of an operation of the system 10 in a case where the analysis system 70 analyzes data in accordance with an instruction made by the analyst.

The analyst can instruct the analyst terminal 140 to log in the analysis system 70 via the operation unit 141 of the analyst terminal 140. When the control unit 145 of the analyst terminal 140 is instructed to log in the analysis system 70, the control unit 145 of the analyst terminal 140 sends a login processing request to the analysis system 70 as shown in FIG. 24 (S361). The control unit 145 of the analyst terminal 140 includes a combination of the analyst ID and the password, which is input from the operation unit 141 of the analyst terminal 140, in the login processing request.

When the analysis unit 75a of the analysis system 70 receives the login processing request sent in S361, the analysis unit 75a of the analysis system 70 executes authentication on the basis of the combination of the analyst ID and the password, which is included in the received login processing request, and the analyst management information 74b (S362). Specifically, in a case where the combination of the analyst ID and the password, which is included in the login processing request sent S361, is included in the analyst management information 74b, the analysis unit 75a determines that the authentication has completed successfully. On the other hand, the analysis unit 75a determines that the authentication has failed in a case where the combination of the analyst ID and the password, which is included in the login processing request sent S361, is not included in the analyst management information 74b.

When the analysis unit 75a determines in S362 that the authentication has completed successfully, the analysis unit 75a notifies the analyst terminal 140 of the login permission (S363).

When the control unit 145 of the analyst terminal 140 receives the notification in S363, the control unit 145 of the analyst terminal 140 displays that the login has been permitted on the display unit 142 of the analyst terminal 140 (S364).

In a case where the analyst has logged into the analysis system 70, the analyst can instruct the analysis system 70 to evaluate the e-mail delivered by the mail delivery system 30 via the analyst terminal 140. When the analysis unit 75a of the analysis system 70 is instructed to evaluate the e-mail delivered by the mail delivery system 30, the analysis unit 75a of the analysis system 70 calculates a utilization rate of the SaaS provided by the SaaS providing system 20 on the basis of the utilization history information 74c (S365).

The analysis unit 75a may calculate a utilization rate of the SaaS by each general user as the utilization rate of the SaaS provided by the SaaS providing system 20.

The analysis unit 75a may calculate the utilization rate of the SaaS provided by the SaaS providing system 20 on the basis of the length of time for which the general user is logged into the SaaS providing system 20. For example, regarding a particular time zone in the most recent particular period, the analysis unit 75a may calculate a total rate of time for which a particular general user is logged into the SaaS providing system 20 to the total time as the utilization rate of the SaaS by this general user. Here, for example, the particular period may be 20 days. For example, the particular time zone may be a partial time zone of each day, such as 8:00 a.m. to 5:00 p.m., or may be the entire time zone of each day, such as 0:00 a.m. to 0:00 a.m. on the next day. For example, regarding the time zone of 8:00 a.m. to 5:00 p.m. in the most recent 20 days, it is assumed that the analysis unit 75a calculates a total rate of time for which a particular general user is logged into the SaaS providing system 20 to the total time as the utilization rate of the SaaS by this general user. In this case, when the total time for which this general user is logged into the SaaS providing system 20 in the time zone of 8:00 a.m. to 5:00 p.m. in the most recent 20 days is 90 hours, the total time of the time zone of 8:00 a.m. to 5:00 p.m. in the most recent 20 days is 180 hours. Therefore, the analysis unit 75a calculates the utilization rate of the SaaS by this general user as 50%.

The analysis unit 75a may calculate a utilization rate of a particular function of the SaaS by the general user as the utilization rate of the SaaS provided by the SaaS providing system 20. For example, the analysis unit 75a may calculate a ratio of the number of days on which a particular general user utilizes the particular function of the SaaS to the total number of days regarding the most recent particular period, as the utilization rate of the SaaS by this general user. Here, for example, the particular period may be 20 days. For example, regarding the most recent 20 days, the analysis unit 75a calculates a ratio of the number of days on which the particular general user utilizes the particular function of the SaaS to the total number of days, as the utilization rate of the SaaS by this general user. In this case, when the number of days on which this general user utilizes the particular function of the SaaS in the most recent 20 days is one day, the analysis unit 75a calculates the utilization rate of the SaaS by this general user as 5%.

The analysis unit 75a may calculate a utilization rate of the SaaS by a group of general users as the utilization rate of the SaaS provided by the SaaS providing system 20. For example, the analysis unit 75a may calculate an average value of the utilization rate of the SaaS by all general users belonging to a particular tenant, as a utilization rate of the SaaS by this tenant.

When the processing in S365 ends, the analysis unit 75a calculates an open rate of the e-mail delivered by the mail delivery system 30 on the basis of the tracking information 74d (S366).

The analysis unit 75a may calculate the open rate by each general user as the open rate of the e-mail delivered by the mail delivery system 30.

The analysis unit 75a may calculate a ratio of the number of e-mails opened by a particular general user to the total number of e-mails regarding all e-mails delivered by the mail delivery system 30 to this general user in a past particular period as an open rate by this general user for the e-mail delivered by the mail delivery system 30. Here, the particular period may be the most recent 20 days. For example, it is assumed that the analysis unit 75a calculates a ratio of the number of e-mails opened by a particular general user to the total number of e-mails regarding all e-mails delivered by the mail delivery system 30 to this general user in the most recent 20 days, as an open rate by this general user for the e-mail delivered by the mail delivery system 30. In this case, when the total number of e-mails delivered by the mail delivery system 30 to this general user is 10 in the most recent 20 days and the number of e-mails opened by this general user out of the e-mails delivered by the mail delivery system 30 to this general user is 2 in the most recent 20 days, the analysis unit 75a calculates the open rate of the e-mails by this general user as 20%.

Regarding a particular e-mail delivered by the mail delivery system 30 to a particular general user, it is assumed that this general user has opened this e-mail. In this case, the analysis unit 75a may calculate the open rate of this e-mail by this general user as 100%. Otherwise, in a case where this general user has not opened this e-mail, the analysis unit 75a may calculate the open rate of this e-mail by this general user as 0%.

When the processing in S366 ends, the analysis unit 75a generates an analysis result related to the e-mails delivered by the mail delivery system 30 on the basis of the utilization rate of the SaaS calculated in S365 and the open rate of the e-mails calculated in S366 (S367).

Regarding the e-mail delivered by the mail delivery system 30, the analysis unit 75a may generate an analysis result related to this e-mail on the basis of the open rate calculated in S366 for each particular range of the utilization rate of the SaaS calculated in S365 with respect to each of the general users to which this e-mail has been delivered by the mail delivery system 30. For example, regarding the e-mail delivered by the mail delivery system 30, the analysis unit 75a may generate an average value of the open rate of general users of the general users to which this e-mail has been delivered by the mail delivery system 30, for which the utilization rate of the SaaS calculated in S365 is lower than a particular value, and an average value of the open rate of general users for which the utilization rate of the SaaS calculated in S365 is equal to or higher than the particular value as the analysis result. For example, regarding the e-mail delivered by the mail delivery system 30, it is assumed that an average value of the open rate of the general users of the general users to which this e-mail has been delivered by the mail delivery system 30, for which the utilization rate of the SaaS calculated in S365 is lower than a particular value, is larger than an average value of the open rate of the general users for which the utilization rate of the SaaS calculated in S365 is equal to or higher than the particular value. In this case, the analysis unit 75a can evaluate that there is a possibility that the e-mail is likely to be opened by the general users with a low utilization rate of the SaaS. Here, for example, the particular value is 30%.

The analysis unit 75a may generate a utilization rate of the SaaS after the date and time of delivery of this e-mail of general users who have received this delivered e-mail and have not opened this e-mail out of general users for which the utilization rate of the SaaS before the date and time of delivery of the e-mail is within the particular range (hereinafter, referred to “particular-range users” in this paragraph), an average value of the utilization rate of the SaaS after the date and time of delivery of this e-mail of general users who have not received this delivered e-mail out of the particular-range users, and an average value of the utilization rate of the SaaS after the date and time of delivery of this e-mail of general users who have received this delivered e-mail and have opened this e-mail out of the particular-range users, as an analysis result. In a case where an average value of the utilization rate of the SaaS after the date and time of delivery of this e-mail of the general users who have received this delivered e-mail and have opened this e-mail out of the particular-range users is higher than the utilization rate of the SaaS after the date and time of delivery of this e-mail of the general users who have received this delivered e-mail and have not opened this e-mail out of the particular-range users and an average value of the utilization rate of the SaaS after the date and time of delivery of this e-mail of general users who have not received this delivered e-mail out of the particular-range users, it is possible to evaluate that there is a possibility that this e-mail has an effect of promoting the utilization of the SaaS for the particular-range users.

The analysis unit 75a may generate an average value of the utilization rate of the SaaS before the date and time of delivery of this e-mail by general users who have delivered this e-mail and opened this e-mail out of general users for which the utilization rate of the SaaS before the date and time of delivery of the e-mail is within the particular range (hereinafter, referred to “particular-range users” in this paragraph), and an average value of the utilization rate of the SaaS after the date and time of delivery of this e-mail by general users who have received this delivered e-mail and have opened this e-mail out of the particular-range users, as an analysis result. In a case where the average value of the utilization rate of the SaaS by the general users who have received this delivered e-mail and have opened this e-mail out of the particular-range users increases before and after the date and time of delivery of this e-mail, it is possible to evaluate that there is a possibility that this e-mail has an effect of promoting the utilization of the SaaS for the particular-range users.

It should be noted that the analysis unit 75a is capable of associating the tenant user in the utilization history information 74c with the tenant user in the tracking information 74d by using an e-mail address.

When the processing in S367 ends, the analysis unit 75a notifies the analyst terminal 140 of the analysis result generated in S367 (S368).

When the control unit 145 of the analyst terminal 140 receives the notification in S368, the control unit 145 of the analyst terminal 140 displays the analysis result notified in S368 on the display unit 142 of the analyst terminal 140 (S369). Therefore, the analyst may be able to recognize, for example, what kind of e-mail content has the effect of promoting the utilization of the SaaS by checking the display in S369, and may be able to improve the e-mail delivered by the mail delivery system 30 to have the effect of promoting the utilization of the SaaS. Moreover, the analyst may be able to recognize, for example, what kind of e-mail content is likely to be opened by checking the display in S369, and may be able to improve the e-mail delivered by the mail delivery system 30 to be likely to be opened. It should be noted that the analyst may be able to recognize, for each range of the utilization rate of the SaaS, for example, what kind of e-mail content has the effect of promoting the utilization of the SaaS and what kind of e-mail content is likely to be opened by checking the display in S369 and may also be able to make the e-mail delivered by the mail delivery system 30 different for each range of the utilization rate of the SaaS.

Hereinabove, the analysis unit 75a of the analysis system 70 calculates the open rate of the e-mails in S366. However, in addition to or instead of the open rate of the e-mails, the analysis unit 75a of the analysis system 70 may calculate the click rate with respect to the e-mail or the click rate of each link included in the e-mail. The analysis unit 75a may calculate a ratio of the number of links actually clicked by this tenant user to the total number of links included in this e-mail, which is a click rate of a particular e-mail delivered by the mail delivery system 30 to a particular tenant user, as the click rate with respect to this e-mail. The analysis unit 75a may generate the analysis result related to the e-mails delivered by the mail delivery system 30 on the basis of the utilization rate of the SaaS calculated in S365 and the click rate with respect to the e-mail. Therefore, for example, the analyst can recognize what kind of e-mail content has the effect of promoting the utilization of the SaaS and recognize by what kind of e-mail content the link is likely to be clicked.

In addition to or instead of the open rate of the e-mails, the analysis unit 75a may calculate the click rate with respect to the e-mail or the click rate of each link included in the e-mail. With respect to a particular link of a particular e-mail delivered by the mail delivery system 30 to the particular general user, the analysis unit 75a may calculate the click rate of this link by this general user as 100% in a case where this general user has clicked this link, and the analysis unit 75a may calculate the click rate of this link by this general user as 0% in a case where this general user has not clicked this link. The analysis unit 75a may generate an evaluation of each link included in the e-mail delivered by the mail delivery system 30 on the basis of the utilization rate of the SaaS calculated in S365 and the click rate of each link included in the e-mail. Therefore, for example, the analyst can recognize cases where the content of link destinations can provide the effect of promoting the utilization of the SaaS.

As described above, the analysis system 70 outputs the analysis result related to the e-mail, which is based on a detection result of the tracking system 60 that detects at least one of the opening of the e-mail delivered by the mail delivery system 30 to the users of the SaaS provided by the SaaS providing system 20 or the clicking of the link in the e-mail and on the utilization rate of the SaaS (S368). It is thus possible to allow the sender to improve the e-mail on the basis of the analysis result. As a result, it is possible to enhance the effect of promoting the utilization of the SaaS by using an e-mail. It is thus possible to reduce the possibility that the customer may cancel the contract for continuously utilizing the SaaS. As a result, it is possible to enhance the Customer LifeTime Value (CLTV) of the customer.

The analysis system 70 divides the users of the SaaS into a plurality of segments in accordance with the utilization rate and shows an open rate of the e-mail for each of the segments as the analysis result. It is thus possible to allow the sender to recognize the e-mail likely to be opened by the users in the particular segment. As a result, it is possible to enhance the effect of promoting the utilization of the SaaS by using an e-mail.

The analysis system 70 divides the users of the SaaS into a plurality of segments in accordance with the utilization rate and shows a click rate of the link for each of the segments as the analysis result. It is thus possible to allow the sender to recognize the e-mail likely to be clicked by the users in the particular segment. As a result, it is possible to enhance the effect of promoting the utilization of the SaaS by using an e-mail.

The analysis system 70 shows the utilization rate before and after opening the e-mail as the analysis result. It is thus possible to allow the sender to recognize an e-mail that has the effect of promoting the utilization of the SaaS. As a result, it is possible to enhance the effect of promoting the utilization of the SaaS by using an e-mail.

The analysis system 70 shows the utilization rate before and after clicking on the link as the analysis result. It is thus possible to allow the sender to recognize a link that has the effect of promoting the utilization of the SaaS. As a result, it is possible to enhance the effect of promoting the utilization of the SaaS by using an e-mail.

In the present embodiment, the SaaS providing system 20, the mail delivery system 30, the tracking system 60, and the analysis system 70 in the system 10 are constituted by different computers. However, at least some of the computers respectively constituting the SaaS providing system 20, the mail delivery system 30, the tracking system 60, and the analysis system 70 may be common. For example, the analysis system 70 may be constituted by the computer common to at least one of the SaaS providing system 20, the mail delivery system 30, or the tracking system 60.

As described above, the analysis system according to the present disclosure outputs the analysis result related to the e-mail based on the detection result of the tracking system that detects at least one of the opening of the e-mail delivered by the mail delivery system to the users of the SaaS provided by the SaaS providing system or the clicking the link in the e-mail and on the utilization rate of the SaaS. It is thus possible to allow a sender to improve the e-mail on the basis of the analysis result. As a result, it is possible to enhance the effect of promoting the utilization of the SaaS by using an e-mail.

The analysis system according to the present disclosure divides the users of the SaaS into the plurality of segments in accordance with the utilization rate and the open rate of the e-mail for each of the segments is shown as the analysis result. It is thus possible to allow the sender to recognize the e-mail likely to be opened by the users in the particular segment. As a result, it is possible to enhance the effect of promoting the utilization of the SaaS by using an e-mail.

The analysis system according to the present disclosure divides the users of the SaaS into the plurality of segments in accordance with the utilization rate and shows the click rate of the link for each of the segments as the analysis result. It is thus possible to allow the sender to recognize the link likely to be clicked by the users in the particular segment. As a result, it is possible to enhance the effect of promoting the utilization of the SaaS by using an e-mail.

The analysis system according to the present disclosure shows the utilization rate before and after opening the e-mail as the analysis result. It is thus possible to allow the sender to recognize an e-mail that has the effect of promoting the utilization of the SaaS. As a result, it is possible to enhance the effect of promoting the utilization of the SaaS by using an e-mail.

The analysis system according to the present disclosure shows the utilization rate before and after clicking on the link as the analysis result. It is thus possible to allow the sender to recognize a link that has the effect of promoting the utilization of the SaaS. As a result, it is possible to enhance the effect of promoting the utilization of the SaaS by using an e-mail.

The system according to the present disclosure outputs the analysis result related to the e-mail based on the detection result of the tracking system that detects at least one of the opening of the e-mail delivered by the mail delivery system to the user of the SaaS provided by the SaaS providing system or the clicking the link in the e-mail and on the utilization rate of the SaaS. Therefore, it is possible to allow the sender to improve the e-mail on the basis of the analysis result. As a result, it is possible to enhance the effect of promoting the utilization of the SaaS by using an e-mail.

The information processing apparatus according to the present disclosure outputs the analysis result related to the e-mail based on the detection result of the tracking system that detects at least one of the opening of the e-mail delivered by the mail delivery system to the user of the SaaS provided by the SaaS providing system or the clicking the link in the e-mail and on the utilization rate of the SaaS. It is thus possible to allow the sender to improve the e-mail on the basis of the analysis result. As a result, it is possible to enhance the effect of promoting the utilization of the SaaS by using an e-mail.

The computer that executes the analysis program according to the present disclosure outputs the analysis result related to the e-mail based on the detection result of the tracking system that detects at least one of the opening of the e-mail delivered by the mail delivery system to the user of the SaaS provided by the SaaS providing system or the clicking the link in the e-mail and on the utilization rate of the SaaS. It is thus possible to allow the sender to improve the e-mail on the basis of the analysis result. As a result, it is possible to enhance the effect of promoting the utilization of the SaaS by using an e-mail.

### Embodiment 2

Hereinafter, Embodiment 2 of the present disclosure will be described with reference to the drawings. It should be noted that descriptions of configurations common to those of Embodiment 1 will be omitted as appropriate.

First of all, a configuration of a system according to Embodiment 2 of the present disclosure will be described.

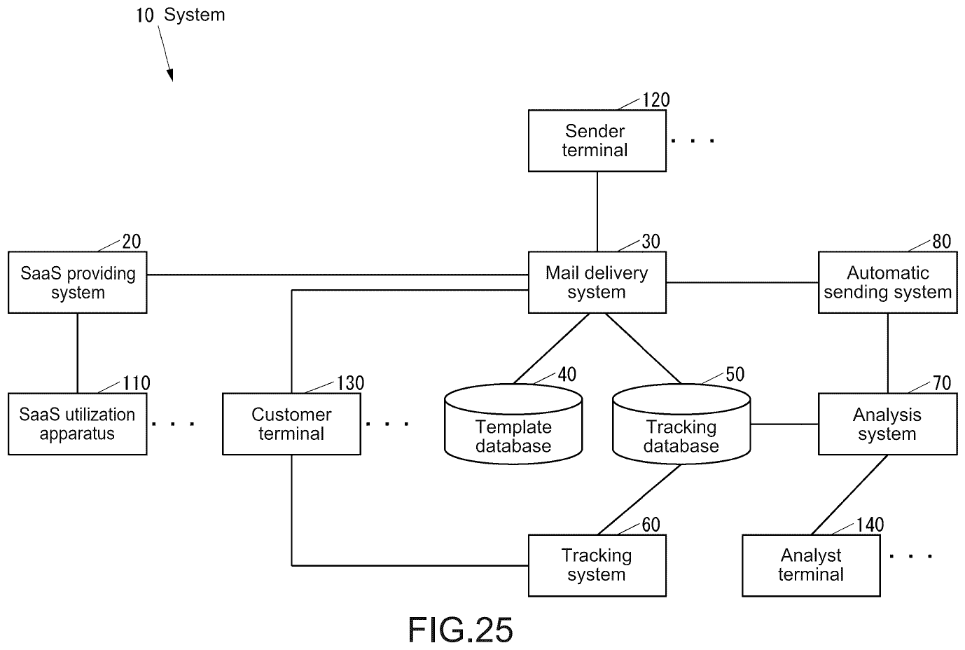

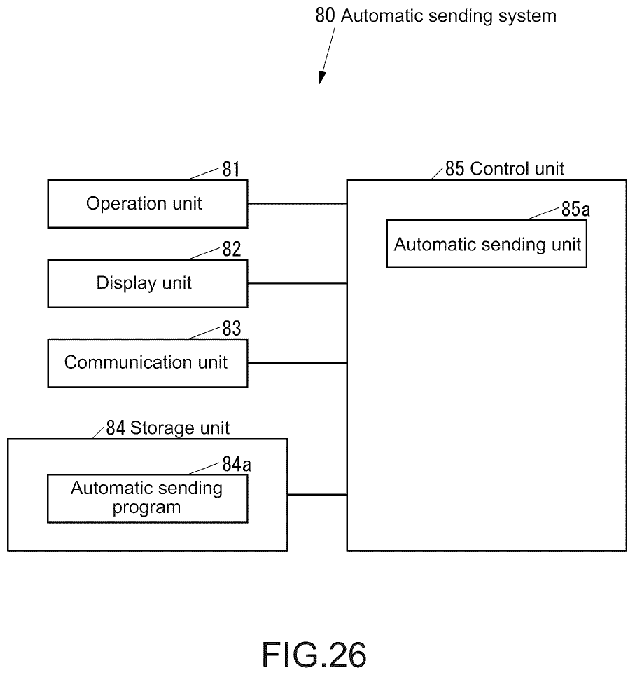

FIG. 25 is a block diagram of an example of the system 10 according to the present embodiment.

The system 10 includes an automatic sending system 80 that automatically sends an e-mail through the mail delivery system 30 in accordance with an analysis result of the analysis system 70. The automatic sending system 80 may be constituted by a single computer such as a PC or may be constituted by a plurality of computers. The automatic sending system 80 may be configured on a cloud.

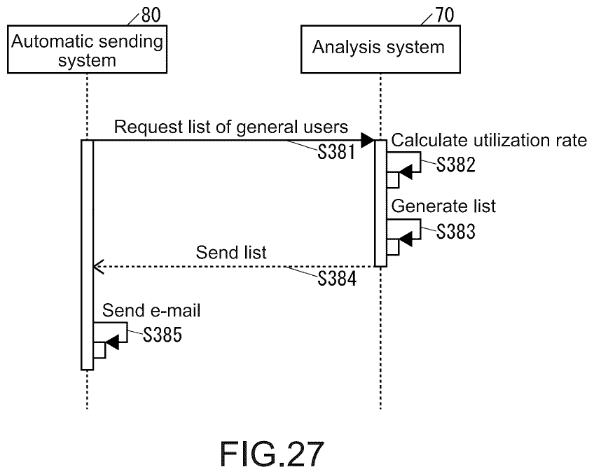

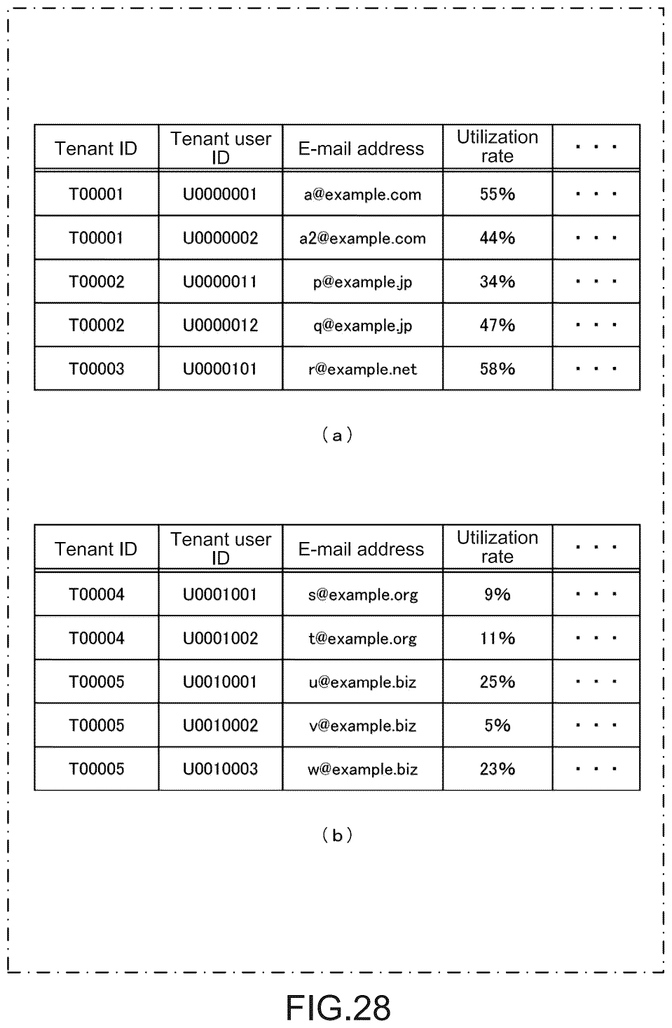

FIG. 27 is a block diagram of an example of the automatic sending system 80 in a case where it is constituted by a single computer.

As shown in FIG. 27, the automatic sending system 80 includes an operation unit 81, a display unit 82, a communication unit 83, a storage unit 84, and a control unit 85. The operation unit 81 is an operation device in which various operations are input, such as keyboard and mouse. The display unit 82 is a display device that displays various types of information, such as an LCD. The communication unit 83 is a communication device that communicates with an external apparatus via a network, such as a LAN or Internet, or directly with a wire or wirelessly via the network. The storage unit 84 is a nonvolatile storage device that stores various types of information, such as a semiconductor memory or HDD. The control unit 85 comprehensively controls the automatic sending system 80.

The storage unit 84 is capable of storing an automatic sending program 84a for sending the e-mail to the mail delivery system 30 in accordance with an analysis result of the analysis system 70. For example, the automatic sending program 84a may be installed in the automatic sending system 80 during the production phase of the automatic sending system 80. Alternatively, for example, the automatic sending program 84a may be additionally installed in the automatic sending system 80 from an external storage medium such as a USB memory. Alternatively, for example, the automatic sending program 84a may be additionally installed in the automatic sending system 80 from the network.

For example, the control unit 85 includes a CPU, a ROM that has stored programs and various data, and a RAM that serves as a memory used as a working area for the CPU of the control unit 85. The CPU of the control unit 85 executes the programs stored in the storage unit 84 or the ROM of the control unit 85.

The control unit 85 realizes an automatic sending unit 85a that sends an e-mail to the mail delivery system 30 in accordance with an analysis result of the analysis system 70 by executing the automatic sending program 84a.

By the way, in a technology in the related art, there is a problem in that it is difficult to promote the utilization of the SaaS by using an e-mail.

In view of this, it is an objective of the present disclosure to provide an automatic sending system, a system, an information processing apparatus, and an automatic sending program storage medium that make it possible to automatically promote the utilization of the SaaS by using an e-mail.

Next, an operation of the system 10 in a case where the automatic sending system 80 sends an e-mail to the mail delivery system 30 in accordance with an analysis result of the analysis system 70 will be described.

FIG. 27 is a sequence diagram of an operation of the system 10 in a case where the automatic sending system 80 sends an e-mail to the mail delivery system 30 in accordance with an analysis result of the analysis system 70.

As shown in FIG. 27, the automatic sending unit 85a of the automatic sending system 80 requests a list of tenant users divided into a plurality of segments in accordance with the utilization rate of the SaaS provided by the SaaS providing system 20 from the analysis system 70 (S381).

When the analysis unit 75a of the analysis system 70 receives the request in S381, the analysis unit 75a of the analysis system 70 calculates the utilization rate of the SaaS provided by the SaaS providing system 20 on the basis of the utilization history information 74c as in the processing in S365 (S382).

When the processing in S382 ends, the analysis unit 75a generates a list of tenant users divided into a plurality of segments in accordance with the utilization rate calculated in S382 (S383).

(a) of FIG. 28 shows a list of tenant users for which the utilization rate of the SaaS provided by the SaaS providing system 20 is equal to or higher than 30%. (b) of FIG. 28 shows a list of tenant users for which the utilization rate of the SaaS provided by the SaaS providing system 20 is lower than 30%.

As shown in FIG. 27, when the processing in S383 ends, the analysis unit 75a sends the list generated in S383 to the automatic sending system 80 (S384).

When the automatic sending unit 85a of the automatic sending system 80 receives the list sent in S384, the automatic sending unit 85a of the automatic sending system 80 causes the mail delivery system 30 to send an e-mail according to the segment corresponding to the list for each received list (S385). For example, the automatic sending unit 85a may cause the mail delivery system 30 to send e-mails for the tenant users for which the utilization rate is lower than 30% to the tenant users for which the utilization rate is lower than 30% and cause the mail delivery system 30 to send e-mails for the tenant users for which the utilization rate is equal to or higher than 30% to the tenant users for which the utilization rate is equal to or higher than 30%. Moreover, the automatic sending unit 85a may cause the mail delivery system 30 to send e-mails to the tenant users for which the utilization rate is lower than 30% more frequently than the tenant users for which the utilization rate is equal to or higher than 30%.

It should be noted that the e-mails automatically sent by the automatic sending system 80 may be generated by the sender, for example, on the basis of an analysis result of the analysis system 70.

The automatic sending system 80 automatically sends e-mails according to the segments of the users of the SaaS, who are divided in accordance with the utilization rate of the SaaS provided by the SaaS providing system 20, to the users of the SaaS (S385). It is thus possible to automatically promote the utilization of the SaaS by using an e-mail.

The automatic sending system 80 sends the e-mail according to the first segment more frequently than the e-mail according to the second segment in the utilization rate higher than the first segment. It is thus possible to enhance the effect of promoting the utilization of the SaaS by using an e-mail.

In the present embodiment, the automatic sending system 80 sends the e-mails using the mail delivery system 30. However, the automatic sending system 80 may send the e-mails by itself without using the mail delivery system 30.

In the present embodiment, the automatic sending system 80 sends the e-mails in the HTML format. However, the automatic sending system 80 may send e-mails other than the e-mails in the HTML format, such as e-mails in a text format.

In the present embodiment, the SaaS providing system 20, the mail delivery system 30, the tracking system 60, the analysis system 70, and the automatic sending system 80 in the system 10 are constituted by different computers. However, at least some of the computers respectively constituting the SaaS providing system 20, the mail delivery system 30, the tracking system 60, the analysis system 70, and the automatic sending system 80 may be common. For example, the analysis system 70 may be constituted by the computer common to at least one of the SaaS providing system 20, the mail delivery system 30, the tracking system 60, or the automatic sending system 80. Similarly, the automatic sending system 80 may be constituted by the computer common to at least one of the SaaS providing system 20, the mail delivery system 30, the tracking system 60, or the analysis system 70.

As described above, the automatic sending system according to the present disclosure automatically sends the e-mail according to the segment of the users of the SaaS, who are divided in accordance with the utilization rate of the SaaS provided by the SaaS providing system, to the users of the SaaS. It is thus possible to automatically promote the utilization of the SaaS by using an e-mail.

The automatic sending system according to the present disclosure sends the e-mail according to the first segment more frequently than the e-mail according to the second segment in the utilization rate higher than the first segment. It is thus possible to enhance the effect of promoting the utilization of the SaaS by using an e-mail.

The system according to the present disclosure automatically sends the e-mail according to the segment of the users of the SaaS, who are divided in accordance with the utilization rate of the SaaS, to the users of the SaaS. It is thus possible to automatically promote the utilization of the SaaS by using an e-mail.

The information processing apparatus according to the present disclosure automatically sends the e-mail according to the segment of the users of the SaaS, who are divided in accordance with the utilization rate of the SaaS provided by the SaaS providing system, to the users of the SaaS. It is thus possible to automatically promote the utilization of the SaaS by using an e-mail.

The computer that executes the automatic sending program according to the present disclosure automatically sends the e-mail according to the segment of the users of the SaaS, who are divided in accordance with the utilization rate of the SaaS provided by the SaaS providing system, to the users of the SaaS. It is thus possible to automatically promote the utilization of the SaaS by using an e-mail.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An analysis system that outputs an analysis result related to an e-mail, the e-mail being delivered by a mail delivery system that delivers the e-mail to users of software as a service (SaaS) provided by a SaaS providing system that provides the SaaS, the analysis result being based on a detection result of a tracking system that detects at least one of opening of the e-mail or clicking of a link in the e-mail and on a utilization rate of the SaaS.

2. The analysis system according to claim 1, wherein
the users of the SaaS are divided into a plurality of segments in accordance with the utilization rate, and
an open rate of the e-mail for each of the segments is shown as the analysis result.

3. The analysis system according to claim 1, wherein
the users of the SaaS are divided into a plurality of segments in accordance with the utilization rate, and
a click rate of the link for each of the segments is shown as the analysis result.

4. The analysis system according to claim 1, wherein
the utilization rate before and after opening the e-mail is shown as the analysis result.

5. The analysis system according to claim 1, wherein
the utilization rate before and after clicking on the link is shown as the analysis result.

6. A system, comprising:
a software as a service (SaaS) providing system that provides SaaS;
a mail delivery system that delivers an e-mail to users of the SaaS provided by the SaaS providing system;
a tracking system that detects at least one of opening of the e-mail delivered by the mail delivery system or clicking of the link in the e-mail; and
an analysis system that outputs an analysis result related to the e-mail, the analysis result being based on a detection result of the tracking system and a utilization rate of the SaaS.

7. The system according to claim 6, wherein
in a case where the SaaS providing system manages a tenant of a particular customer and a manager of the tenant of the particular customer, when the SaaS providing system does not manage at least one of general users of the tenant of the particular customer, who are the users of the SaaS, or initial settings with respect to the tenant of the particular customer, the SaaS providing system determines a phase of utilization of the particular customer with respect to the SaaS as a particular phase,
in a case where the SaaS providing system determines that the phase of utilization of the particular customer with respect to the SaaS is the particular phase, when a particular period or more has elapsed since the SaaS providing system first determined that the phase of utilization of the particular customer with respect to the SaaS is the particular phase, the SaaS providing system instructs the mail delivery system to send to the manager of the tenant of the particular customer an e-mail for requesting the manager of the tenant of the particular customer to proceed the phase of utilization of the particular customer with respect to the SaaS to a phase subsequent to the particular phase.

8. The system according to claim 6, wherein
in a case where the SaaS providing system manages a tenant of a particular customer, a manager of the tenant of the particular customer, general users of the tenant of the particular customer, who are the users of the SaaS, and initial settings with respect to the tenant of the particular customer, when a history of utilization of the SaaS by the general users of the tenant of the particular customer does not exist, the SaaS providing system determines the phase of utilization of the particular customer with respect to the SaaS as a particular phase, and
in a case where the SaaS providing system determines that the phase of utilization of the particular customer with respect to the SaaS is the particular phase, when a particular period or more has elapsed since the SaaS providing system first determined that the phase of utilization of the particular customer with respect to the SaaS is the particular phase, the SaaS providing system instructs the mail delivery system to send to the manager of the tenant of the particular customer an e-mail for requesting the manager of the tenant of the particular customer to proceed the phase of utilization of the particular customer with respect to the SaaS to a phase subsequent to the particular phase.

9. An automatic sending system that automatically sends an e-mail according to a segment of users of software as a service (SaaS), who are divided in accordance with a utilization rate of SaaS provided by a SaaS providing system that provides the SaaS, to the users of the SaaS.

10. The automatic sending system according to claim 9, wherein
the e-mail according to a first segment, which is the segment, is sent more frequently than the e-mail according to a second segment, which is the segment higher in the utilization rate than the first segment.
